(19) United States
(12) Patent Application Publication
(10) Pub. No.: US 2003/0028501 A1
(43) Pub. Date: Feb. 6, 2003

(54) COMPUTER BASED METHOD FOR PROVIDING A LABORATORY INFORMATION MANAGEMENT SYSTEM

(76) Inventors: DAVID J. BALABAN, CUPERTINO, CA (US); ELINA KHURGIN, CUPERTINO, CA (US); DEREK H. BERNHART, PALO ALTO, CA (US); JOHN SOWATSKY, FREMONT, CA (US); AURN AGGARWAL, MOUNTAIN VIEW, CA (US); LUIS JEVONS, SUNNYVALE, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(21) Appl. No.: 09/397,494

(22) Filed: Sep. 15, 1999

Related U.S. Application Data
(60) Provisional application No. 60/100,724, filed on Sep. 17, 1998.
(60) Provisional application No. 60/100,740, filed on Sep. 17, 1998.

(51) Int. Cl. G06F 7/00

(52) U.S. Cl. 707/1

(57) ABSTRACT

According to an embodiment of the present invention, a computer based method for managing information about a plurality of experiments conducted on a plurality of samples is provided. Each experiment provides an indication of a degree of expression of particular genetic sequences in a sample. The method includes a variety of steps such as registering at least one of the plurality of samples with a centralized database. The method then includes steps of tracking a plurality of information about the samples and tracking a plurality of information about the experiments. A step of producing a sample history about the plurality of samples from the plurality of information is also a part of the method. The method filters the information about the experiments and the information about the samples according to filters selected by a user. The information is made available for publishing to a variety of targets such as a public database. The combination of these steps can provide a web based user interface to the user to enable the user to access the information.

### CROSS-REFERENCES TO RELATED APPLICATIONS

This application claims priority from the following U.S. Provisional Applications, the entire disclosure of which, including all appendices and all attached documents, is incorporated by reference in its entirety for all purposes:

U.S. Provisional Patent Application No. 60/100,724 filed on Sep. 17, 1998, entitled METHOD AND APPARATUS FOR PROVIDING A LABORATORY INFORMATION MANAGEMENT SYSTEM, (Attorney Docket Number 018547-037500US); and

U.S. Provisional Patent Application No. 60/100,740 filed on Sep. 17, 1998, entitled METHOD AND APPARATUS FOR PROVIDING AN EXPRESSION DATA MINING DATABASE, (Attorney Docket Number 018547-033840US).

Furthermore, commonly owned, copending U.S. patent application Ser. No. 09/122,167, entitled METHOD AND APPARATUS FOR PROVIDING A BIOINFORMATICS DATABASE, filed on Jul. 24, 1998; and

U.S. patent application Ser. No. 09/122,434, entitled GENE EXPRESSION AND EVALUATION SYSTEM, filed Jul. 24, 1998 are herein incorporated by reference.

### STATEMENT AS TO RIGHTS TO INVENTIONS MADE UNDER FEDERALLY SPONSORED RESEARCH AND DEVELOPMENT

Research leading to portions of the present invention was funded by the Department of Commerce through the National Institute of Standards and Technology.

### BACKGROUND OF THE INVENTION

The present invention relates to computer systems and more particularly to computer systems for managing laboratory operations for gene expression monitoring, sequencing and sequence checking.

Information on expression of genes or expressed sequence tags may be collected on a large scale in many ways, including probe array techniques. For example, PCT application WO92/10588, incorporated herein by reference for all purposes, describes techniques for sequencing or sequence checking nucleic acids and other materials. Probes for performing these operations may be formed in arrays according to the methods of, for example, the pioneering techniques disclosed in U.S. Pat. No. 5,143,854 and U.S. Pat. No. 5,571,639, both incorporated herein by reference for all purposes. One of the objectives in collecting this information is the identification of genes or ESTs whose expression is of particular importance.

Computer-aided techniques for monitoring gene expression using such arrays of probes have been developed as disclosed in EP Pub. No. 0848067 and PCT publication No. WO 97/10365, the contents of which are herein incorporated by reference. Many disease states are characterized by differences in the expression levels of various genes either through changes in the copy number of the genetic DNA or through changes in levels of transcription (e.g., through control of initiation, provision of RNA precursors, RNA processing, etc.) of particular genes. For example, losses and gains of genetic material play an important role in malignant transformation and progression. Furthermore, changes in the expression (transcription) levels of particular genes (e.g., oncogenes or tumor suppressors), serve as signposts for the presence and progression of various cancers.

Collecting vast amounts of expression data from large numbers of samples including the tissue types is but the first step in automating genetic expression sequence analysis. To achieve greater efficiencies in the process of collecting and storing expression data, one looks for improved methods to efficiently manage the operations and data collection in the laboratory conducting gene expression sequence analysis.

### SUMMARY OF THE INVENTION

The present invention provides techniques for improved monitoring of genetic expression or sequence analysis. More particularly, the present invention provides a method for managing laboratory operations for monitoring expression or performing sequence analysis.

According to an embodiment of the present invention, a computer based method for managing information about a plurality of experiments conducted on a plurality of samples is provided. Each experiment can provide an indication of the degree that particular genes are expressed in a sample. The method includes a variety of steps such as registering at least one of the plurality of samples with a centralized database. The method can include steps of tracking a plurality of information about the samples and tracking a plurality of information about the experiments. A step of producing a sample history about the plurality of samples from the plurality of information can also be a part of the method. The method can include filtering the information about the experiments and the information about the samples according to parameters selected by a user. The information can be made available for publishing to a variety of targets such as a public database. The combination of these steps can provide a web based user interface that can enable the user to access the information.

In many embodiments, the experimental result information can be entered in a format that can provide cross platform use and sharing of the information. One such format is Genetic Analysis Technology Consortium (“GATC”), a standard for genomic databases provided by Molecular Dynamics, of Hayward, Calif., and Affymetrix, Inc., of Santa Clara, Calif. Reference may be had to http://www.gatconsortium.org for further information about GATC. However, many embodiments can use other standard formats, such as those commonly known in the art.

In another aspect according to the present invention, a method for viewing the results of a plurality of experiments which are stored in at least one database is provided. The method includes a variety of steps such as specifying a database to query. One or more queries can be submitted to form a result. The user can then view the result. The result may be filtered according to one or more user specified factors of interest in order to form a filtered result, which can be put into a graphical form, for example, for ease of viewing.

Numerous benefits are achieved by way of the present invention over conventional techniques. In some embodiments, the present invention is more cost effective than conventional techniques. The present invention can also provide a graphical indication of laboratory analysis processes that is substantially clear for viewing. Some embodiments according to the invention are less complex than known techniques. These and other benefits are described throughout the present specification and more particularly below.

The invention will be better understood upon reference to the following detailed description and its accompanying drawings.

### BRIEF DESCRIPTION OF THE DRAWINGS

FIG. 1 illustrates an overall system and process for forming and analyzing arrays of biological materials such as DNA or RNA in a particular embodiment according to the present invention;

FIGS. 2A-2B illustrate computer systems suitable for use in conjunction with the overall system of FIG. 1 in a particular embodiment according to the present invention;

FIGS. 3A-3C illustrate simplified flowcharts of representative process steps according to particular embodiments according to the invention;

FIGS. 4A-4B illustrate representative database structures and data formats in a particular embodiment according to the present invention;

FIGS. 5A-5C illustrate representative automation screens in a particular embodiment according to the present invention;

FIGS. 6A-6H illustrate representative expression analysis screens in a particular embodiment according to the present invention;

FIGS. 7A-7C illustrate representative expression analysis screens for working with sets in a particular embodiment according to the present invention;

FIGS. 8A-8G illustrate representative expression data mining screens in a particular embodiment according to the present invention;

FIGS. 9A-9F illustrate representative annotation screens in a particular embodiment according to the present invention; and

FIGS. 10A-10F illustrate representative function screens in a particular embodiment according to the present invention.

### DESCRIPTION OF THE SPECIFIC EMBODIMENTS

One embodiment of the present invention operates in the context of a system for analyzing biological or other materials using arrays that themselves include probes that may be made of biological materials such as RNA or DNA. The VLSIPS™ and GeneChip™ technologies provide methods of making and using very large arrays of polymers, such as nucleic acids, on very small chips. See U.S. Pat. No. 5,143,854 and PCT Patent Publication Nos. WO 90/15070 and 92/10092, each of which is hereby incorporated by reference for all purposes. Nucleic acid probes on the chip are used to detect complementary nucleic acid sequences in a sample nucleic acid of interest (the “target” nucleic acid).

It should be understood that the probes need not be nucleic acid probes but may also be other polymers such as peptides. Peptide probes may be used to detect the concentration of peptides, polypeptides, or polymers in a sample. The probes should be carefully selected to have bonding affinity to the compound whose concentration they are to be used to measure.

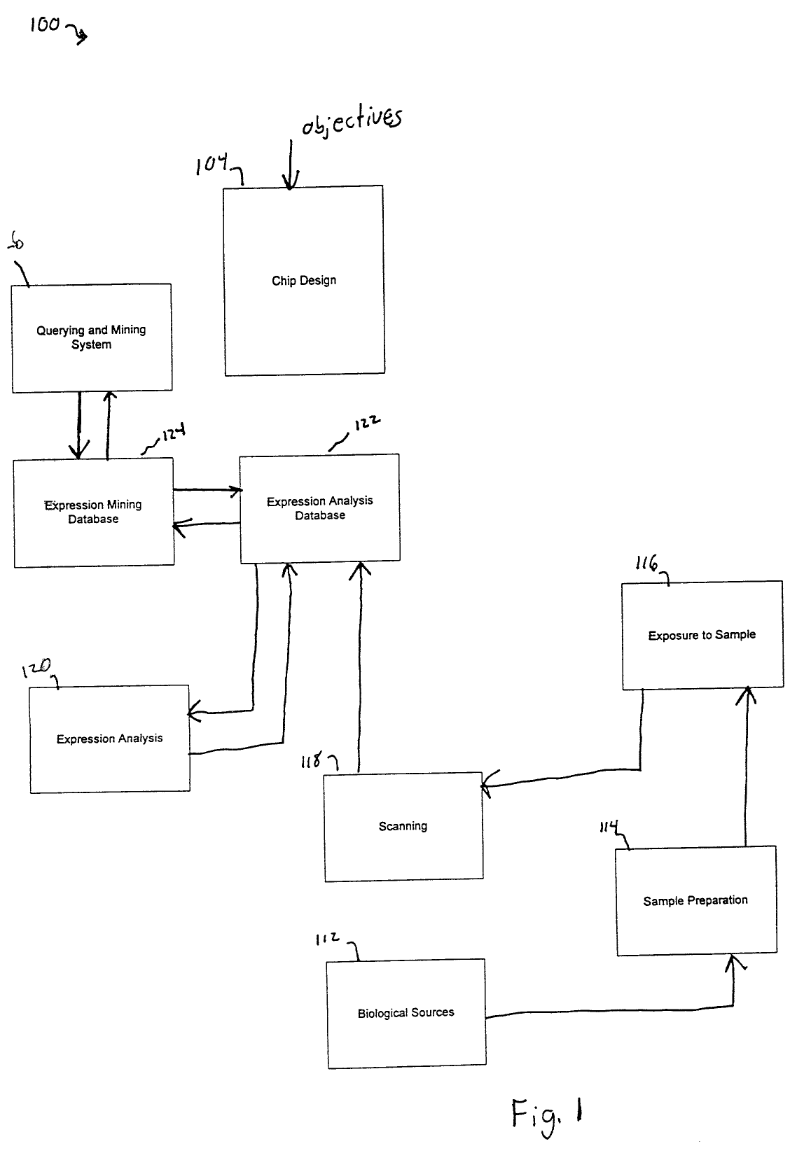

FIG. 1 illustrates an overall system 100 for forming and analyzing arrays of biological materials such as RNA or DNA. This diagram is merely an illustration and should not limit the scope of the claims herein. One of ordinary skill in the art would recognize other variations, modifications, and alternatives. A chip design system 104 is used to design arrays of polymers such as biological polymers such as RNA or DNA. Chip design system 104 may be, for example, an appropriately programmed Sun Workstation or personal computer or workstation, such as an IBM PC equivalent, including appropriate memory and a CPU. Chip design system 104 obtains inputs from a user regarding chip design objectives including characteristics of genes of interest, and other inputs regarding the desired features of the array. Optionally, chip design system 104 may obtain information regarding a specific genetic sequence of interest from bioinformatics database 102 or from external databases such as GenBank. The output of chip design system 104 is a set of chip design computer files in the form of, for example, a switch matrix, as described in PCT application WO 92/10092, and other associated computer files. Systems for designing chips for sequence determination and expression analysis are disclosed in U.S. Pat. No. 5,571,639 and in PCT application WO 97/10365, the contents of which are herein incorporated by reference.

The chip design files are input to a mask design system (not shown) that designs the lithographic masks used in the fabrication of arrays of molecules such as DNA. The mask design system designs the lithographic masks used in the fabrication of probe arrays. The mask design system generates mask design files that are then used by a mask construction system (not shown) to construct masks or other synthesis patterns such as chrome-on-glass masks for use in the fabrication of polymer arrays.

The masks are used in a synthesis system (not shown). The synthesis system includes the necessary hardware and software used to fabricate arrays of polymers on a substrate or chip. The synthesis system includes a light source and a chemical flow cell on which the substrate or chip is placed. A mask is placed between the light source and the substrate/chip, and the two are translated relative to each other at appropriate times for deprotection of selected regions of the chip. Selected chemical reagents are directed through the flow cell for coupling to deprotected regions, as well as for washing and other operations. The substrates fabricated by the synthesis system are optionally diced into smaller chips. The output of the synthesis system is a chip ready for application of a target sample. Information about the mask design, mask construction, and probe array synthesis systems is presented by way of background.

A biological source 112 is, for example, tissue from a plant or animal. Various processing steps are applied to material from biological source 112 by a sample preparation system 114. These steps may include isolation of mRNA, precipitation of the mRNA to increase concentration. The result of the various processing steps is a target sample ready for application to the chips produced by the synthesis system 110. Sample preparation methods for expression analysis are discussed in detail in WO97/10365.

The prepared samples include nucleic acid sequences such as RNA or DNA. When the sample is applied to the chip by a sample exposure system 116, the nucleic acids in the sample may or may not bond to the probes. The nucleic acids have been tagged with fluorescein labels to determine which probes have bonded to nucleic acid sequences from the sample. The prepared samples will be placed in a scanning system 118. Scanning system 118 includes a detection device such as a confocal microscope or CCD (charge-coupled device) that is used to detect the location where labeled receptors have bound to the substrate. The output of scanning system 118 is an image file(s) indicating, in the case of fluorescein labeled receptor, the fluorescence intensity (photon counts or other related measurements, such as voltage) as a function of position on the substrate. Since higher photon counts will be observed where the labeled target has bound more strongly to the array of polymers, and since the monomer sequence of the polymers on the substrate is known as a function of position, it becomes possible to determine the sequence(s) of the target on the substrate that are complementary to the probes.

The image files and the design of the chips are input to an analysis system 120 that, e.g., calls base sequences, or determines expression levels of genes or expressed sequence tags. The expression level of a gene or EST is herein understood to be the concentration within a sample of mRNA or protein that would result from the transcription of the gene or EST. Such analysis techniques are disclosed in WO97/10365 and U.S. application Ser. No. 08/531,137, the contents of which are herein incorporated by reference.

An expression analysis database 122 maintains information used to analyze expression and the results of expression analysis. Contents of expression analysis database 122 may include tables listing analyses performed, analysis results, experiments performed, sample preparation protocols and parameters of these protocols, chip designs, etc. Details of one embodiment of expression analysis database 122 are described in U.S. patent application Ser. No. 09/122,167, entitled METHOD AND APPARATUS FOR PROVIDING A BIOINFORMATICS DATABASE, filed on Jul. 24, 1998, the contents of which are incorporated herein by reference for all purposes.

One or more instantiations of expression analysis database 122 may contain information concerning the expression of many genes or ESTs as collected from many different tissue samples. It would be useful to use this information to investigate questions such as, e.g., 1) which genes or ESTs are upregulated (expressed more) in diseased tissue and downregulated (expressed less) in disease tissue, 2) how does gene expression vary among organs and tissue types within a species, 3) how does gene expression vary among species which share common genes, 4) how does gene expression respond to various disease treatment regimes, 5) how does gene expression vary with progression of disease, etc.

To facilitate investigations of this kind, an expression mining database 124 is provided. Expression mining database 124 may include duplicate representations of data in expression analysis database. Expression mining database 124 may also include various tables to facilitate mining operations conducted by a user who operates a querying and mining system 126. Querying and mining system 126 includes a user interface that permits an operator to make queries to investigate expression of genes and ESTs and answer the types of questions identified above. An example of a querying and mining system is described in a commonly owned U.S. patent application Ser. No. 09/122,434, entitled GENE EXPRESSION AND EVALUATION SYSTEM, filed Jul. 24, 1998.

Chip design system 104, analysis system 120 and control portions of exposure system 116, sample preparation system 114, and scanning system 118 may be appropriately programmed computers such as a Sun workstation or IBM-compatible PC. An independent computer for each system may perform the computer-implemented functions of these systems or one computer may combine the computerized functions of two or more systems. One or more computers may maintain expression analysis database 122, expression mining database 124, and querying and mining system 126 independent of the computers operating the systems of FIG. 1.

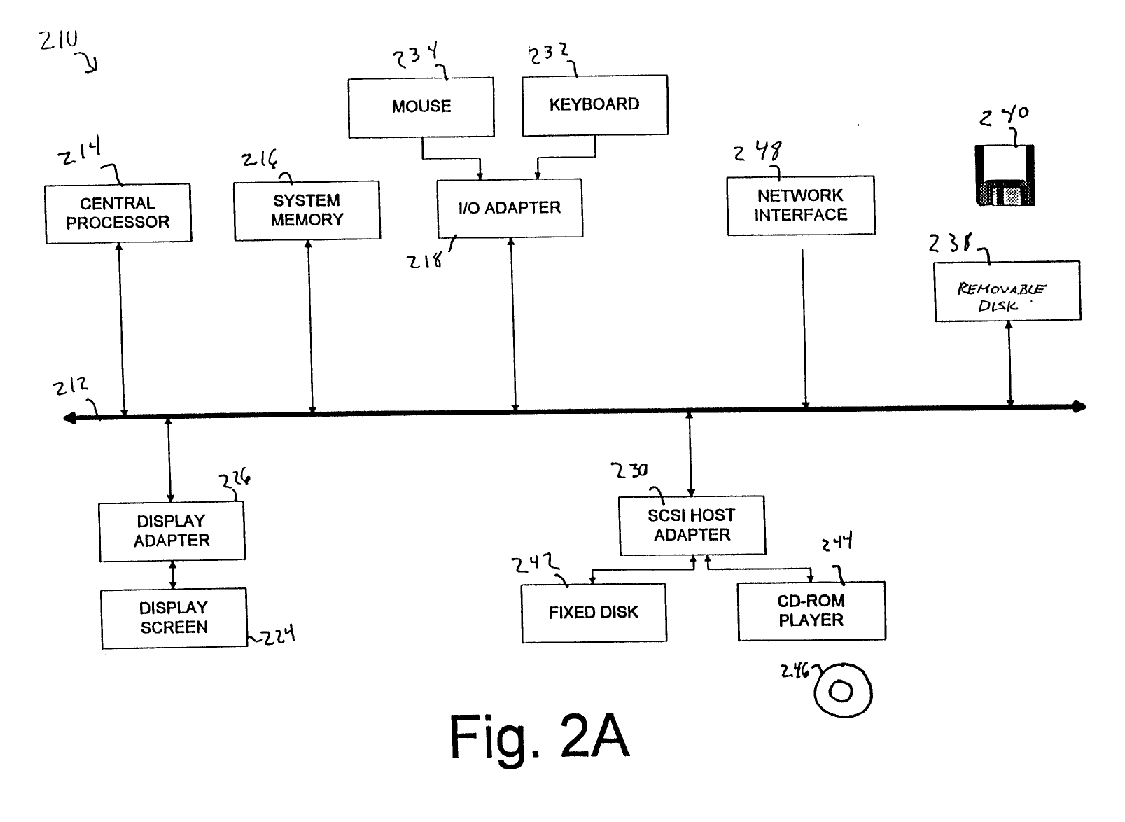

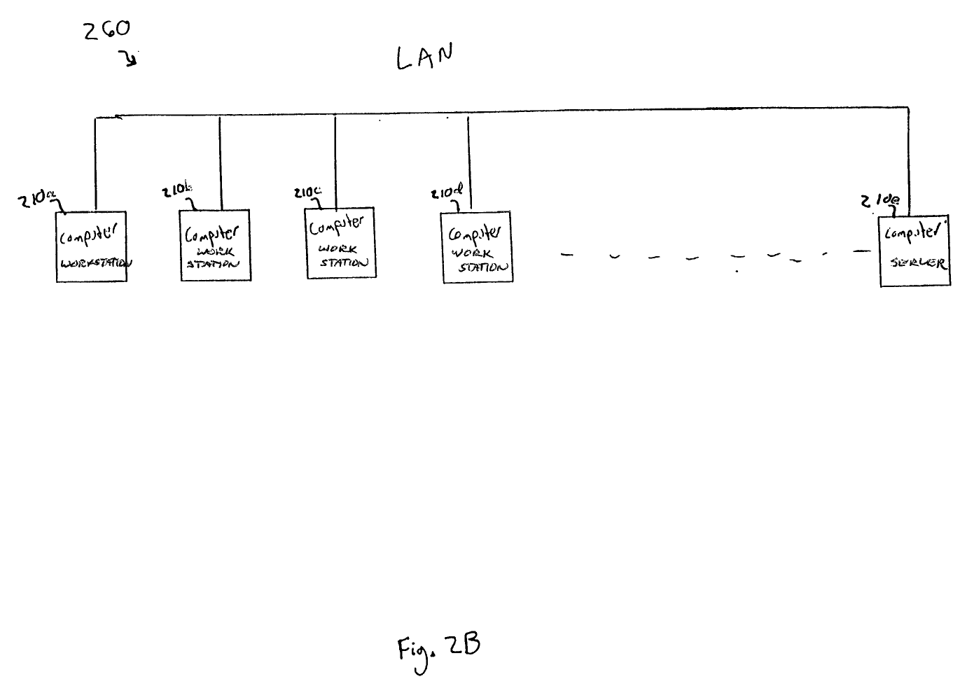

FIG. 2A depicts a block diagram of a host computer system 10 suitable for implementing a particular embodiment according to the present invention. This diagram is merely an illustration and should not limit the scope of the claims herein. One of ordinary skill in the art would recognize other variations, modifications, and alternatives. FIG. 2A illustrates a host computer system 210 including a bus 212 which interconnects major subsystems such as a central processor 214, a system memory 216 (typically RAM), an input/output (I/O) adapter 218, an external device such as a display screen 224 via a display adapter 226, a keyboard 232 and a mouse 234 via an I/O adapter 218, a SCSI host adapter 236, and a removable disk drive 238 operative to receive a removable disk 240. SCSI host adapter 236 may act as a storage interface to a fixed disk drive 242 or a CD-ROM player 244 operative to receive a CD-ROM 246. Fixed disk 244 may be a part of host computer system 210 or may be separate and accessed through other interface systems. A network interface 248 may provide a direct connection to a remote server via a telephone link or to the Internet. Network interface 248 may also connect to a local area network (LAN) or other network interconnecting many computer systems. Many other devices or subsystems (not shown) may be connected in a similar manner.

Also, it is not necessary for all of the devices shown in FIG. 2A to be present to practice the present invention, as discussed below. The devices and subsystems may be interconnected in different ways from that shown in FIG. 2A. The operation of a computer system such as that shown in FIG. 2A is readily known in the art and is not discussed in detail in this application. Code to implement the present invention, may be operably disposed or stored in computer-readable storage media such as system memory 216, fixed disk 242, CD-ROM 246, or floppy disk 240.

FIG. 2B depicts a network 260 interconnecting multiple computer systems 210(a)-210(e) suitable for implementing a particular embodiment according to the present invention. This diagram is merely an illustration and should not limit the scope of the claims herein. One of ordinary skill in the art would recognize other variations, modifications, and alternatives. Network 260 may be a local area network (LAN), wide area network (WAN), and the like. Bioinformatics database 102 and the computer-related operations of the other elements of FIG. 2B may be divided among computer systems 210 in any way with network 260 being used to communicate information among the various computers. Portable storage media such as removable disks may be used to carry information between computers instead of network 260.

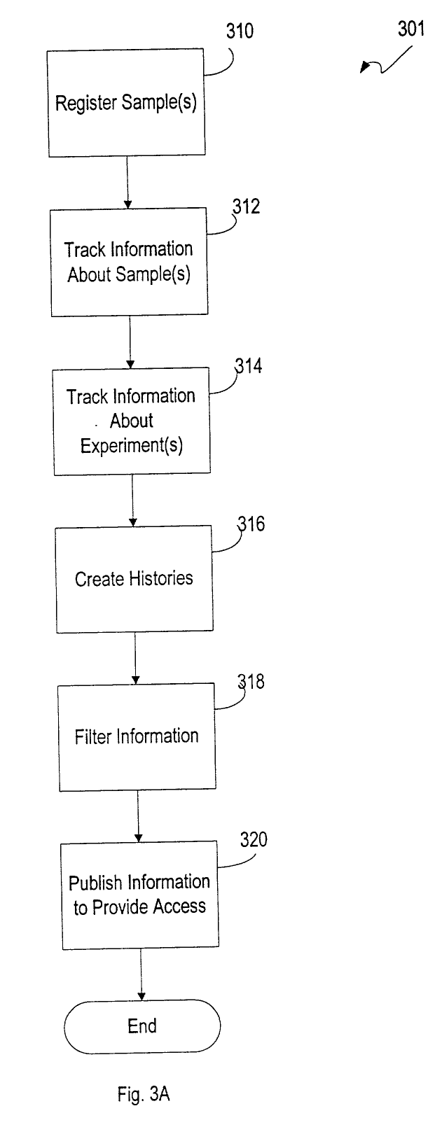

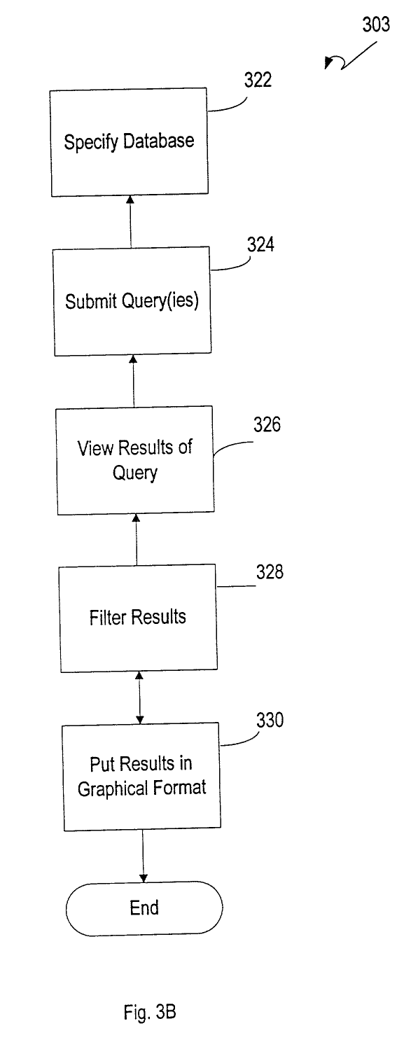

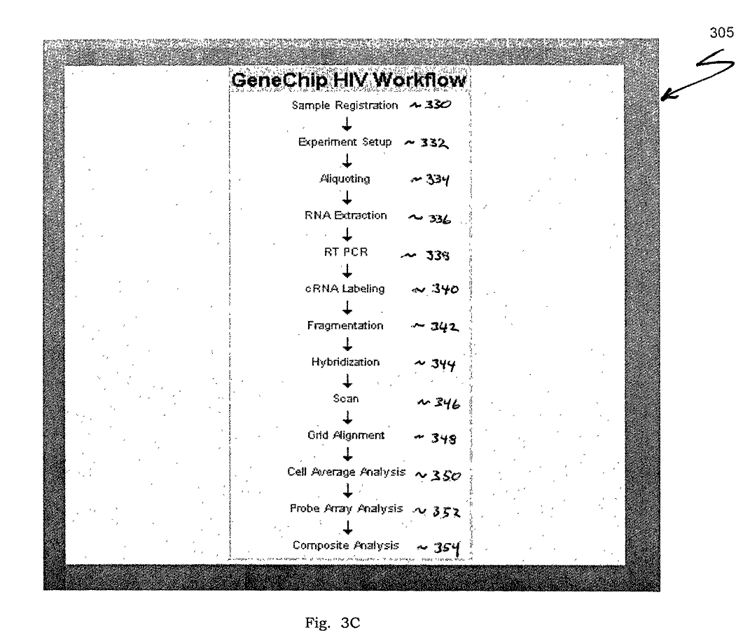

FIG. 3A depicts a flowchart 301 of simplified process steps for managing information about a plurality of experiments conducted on a plurality of samples in a particular representative embodiment according to the present invention. This diagram is merely an illustration and should not limit the scope of the claims herein. One of ordinary skill in the art would recognize other variations, modifications, and alternatives. Each experiment can provide an indication of a degree of expression of particular genetic sequences in a sample. In a step 310, at least one of the plurality of samples is registered with a centralized database. Next, in a step 312, a plurality of information about the plurality of samples is tracked. The result of step 312 is that the information about samples can be incorporated into the database. Then, in a step 314, a plurality of information about the plurality of experiments is tracked. Changes to the experimental environment in the laboratory are reflected in the database by the function of step 314. Now, in a step 316, a sample history is produced from the information in the database. The sample history describes the state of the plurality of samples. In a step 318, the information about the plurality of experiments and the information about the plurality of samples is filtered according to one or more filters selected by a user to produce expression sequence information. Finally, in an optional step 320, the expression sequence information resulting from the operation of the experiments in the laboratory can be published on a public database which can be accessed by a web based user interface or other means.

FIG. 3B depicts a flowchart 303 of simplified process steps for viewing the results of a plurality of samples in another embodiment according to the present invention. This diagram is merely an illustration and should not limit the scope of the claims herein. One of ordinary skill in the art would recognize other variations, modifications, and alternatives. The results can be stored in one or more databases. In a step 322, the user specifies a database to query. Next, in a step 324, one or more queries is submitted to the database in order to form a result. Then, in a step 326, the result can be viewed by the user by means of a display. In a step 328, the result can be filtered according to one or more user specified filters. Finally, in a step 330, the filtered result can be placed into a graphical form.

FIG. 3C provides a representative flow chart 305 of simplified process steps for managing information about a plurality of experiments conducted on samples in a particular embodiment according to the present invention. This diagram is merely an illustration and should not limit the scope of the claims herein. One of ordinary skill in the art would recognize other variations, modifications, and alternatives. In step 330, the sample is registered with a database. Then, in a step 332 the experiment setup is performed. In a step 334 aliquoting is performed. Then, in step 336 RNA is extracted. A polymerized chain reaction (PCR) is performed on the RNA in a step 338. In a step 340 cRNA is labeled. In a step 342, fragmentation is performed. Hybridization is performed in a step 344. In a step 346, scanning of the hybridized chip is performed. Then in a step 348, grid alignment is performed. Cell average analysis is performed in a step 350. In a step 352, probe array analysis is performed, and in a step 354 a composite analysis is performed.

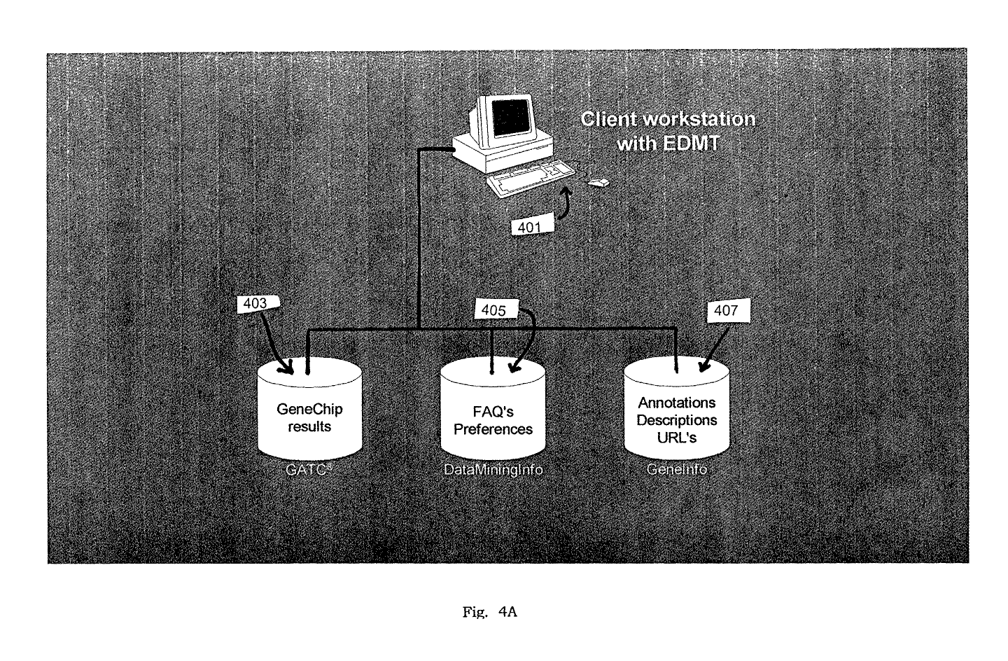

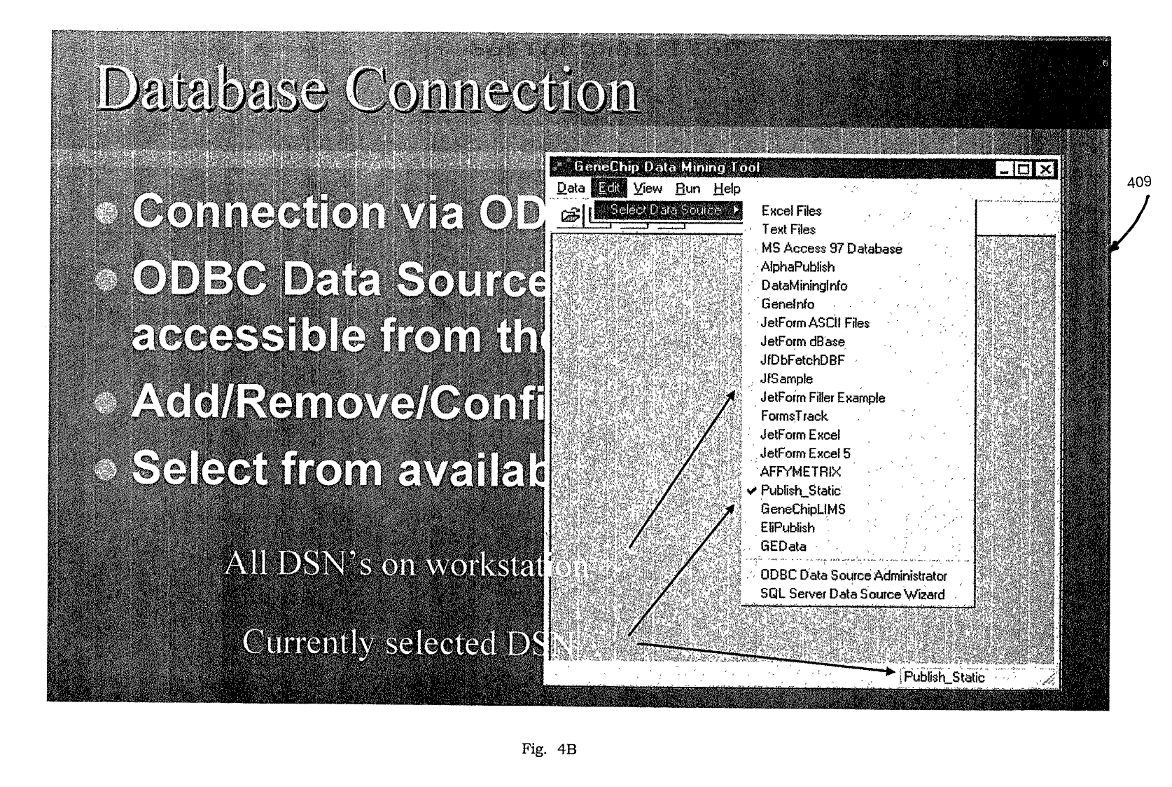

FIG. 4A illustrates a representative a database structure in a particular embodiment according to the present invention. This diagram is merely an illustration and should not limit the scope of the claims herein. One of ordinary skill in the art would recognize other variations, modifications, and alternatives. FIG. 4A illustrates a client work station 401, which can be one of the workstations 210 of FIG. 2B, for example, that can be interconnected with one or more of a plurality of databases. For example, GATC database 403 contains a plurality of gene chip results in GATC format. GATC format provides a standardized interface for gene chip data across multiple systems. Reference may be had to http://www.gatconsortium.org for documents entitled, “Software Specifications” and “Database Schema,” incorporated herein by reference in its entirety for all purposes, for further information about GATC. Database 405 provides data mining information, and can include FAQs and preferences. Database 407 comprises annotations, descriptions and URLs for gene information. Embodiments can include all of the above databases, or can comprise a subset of the databases, or still further can include other databases without departing from the scope of the claimed invention.

The database structure of FIG. 4A can provide data management functions, data publishing functions, and integration with gene chip clients such as client 401. Data management functions can comprise a Laboratory Information Management System (LIMS). Embodiments implementing LIMS according to the present invention can provide functions of data tracking, such as process inputs, process outputs and process environments. Data security functions such as authentication, access permissions and privileges, can include separating owners having write access and user groups with read-only access. Data sharing functions can provide for group access to data. Data publishing and sharing can be facilitated by compliance with a standardized data format. In a presently preferred embodiment, GATC format can be used. This standardized format provides cross-system access to gene chip data. In a preferable embodiment, the database server can be an Internet server providing web browser access. Embodiments can include scripting capability and can provide analyses functions at the server. Some embodiments can provide communications with the database application through web applications, such as browsers and the like, and gene chip interfaces. Databases can be embodied in a server such as an SQL server, an ORACLE server and the like. The database server can be resident on a number of platforms such as an ORACLE NT, UNIX and the like.

FIG. 4B illustrates a data source selection window 409 having a plurality of data sources from which gene and experiment information can be obtained, searched, and manipulated in a particular embodiment according to the present invention. This diagram is merely an illustration and should not limit the scope of the claims herein. One of ordinary skill in the art would recognize other variations, modifications, and alternatives. FIG. 4B illustrates a plurality of different database formats including, but not limited to, MICROSOFT EXCEL files, text files, MICROSOFT ACCESS 97 Database, AlfaPublish, DataMiningInfo, GeneInfo, JetForm ASCII files, JetForm dBase, JfDbFetchDBF, JfSample, JetForm Filler Example, Forms Track, JetForm Excel, JetForm Excel 5, AFFYMETRIX, Publish_Static, GeneChipLIMS, EliPublish, GEData, and others.

Many embodiments according to the present invention can provide for automation of experimental data collection and analyses, as well as publication of results. Many embodiments according to the present invention can provide expression analysis, sample registration and result publication for a plurality of experiments for a particular sample, as well as for a plurality of samples. Additionally, the methods and techniques of the present invention can automate the definition of user parameters for analyses and the like.

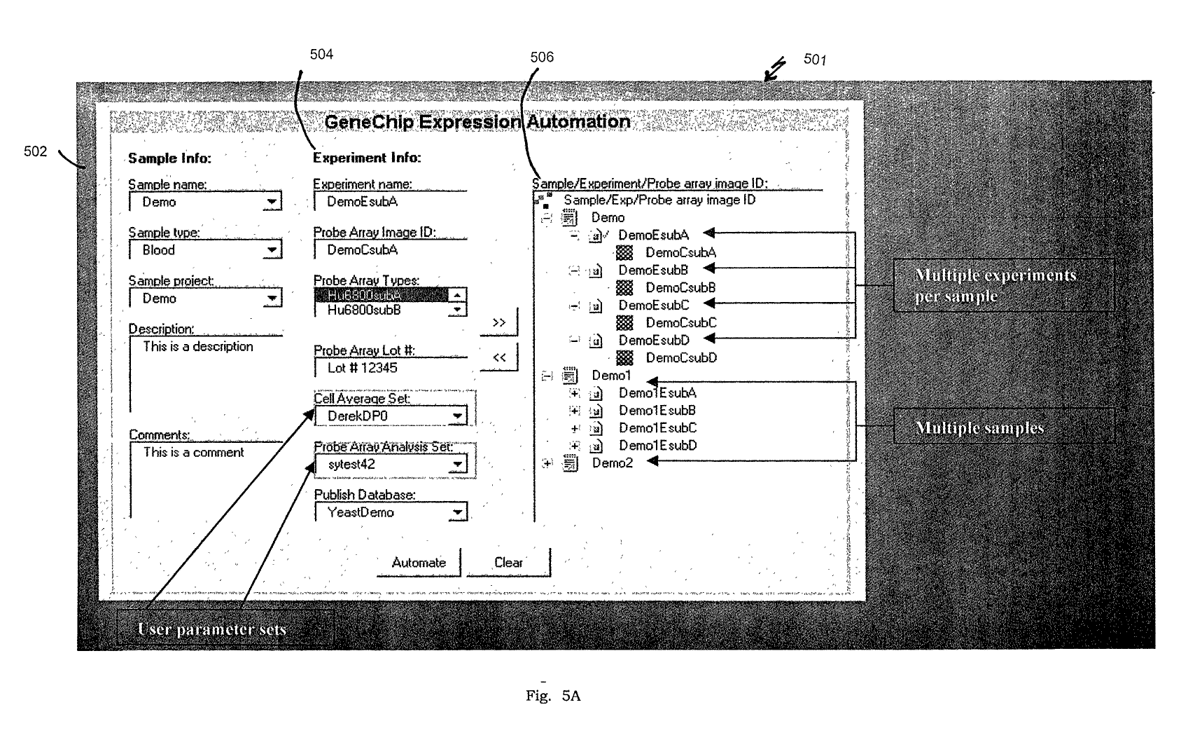

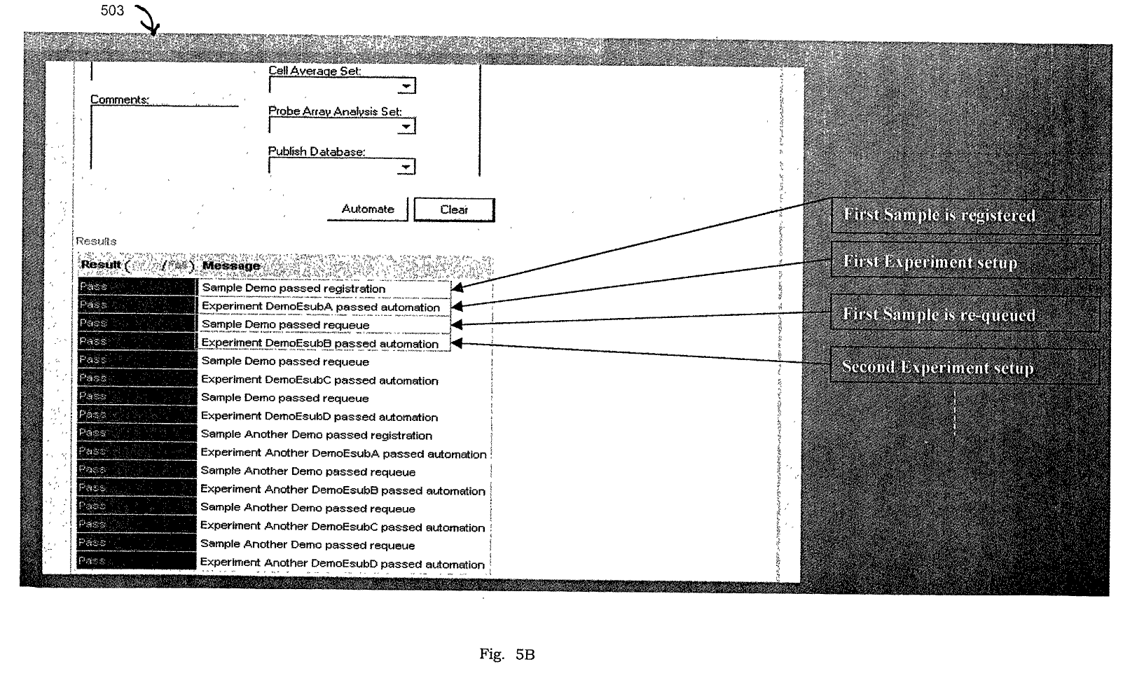

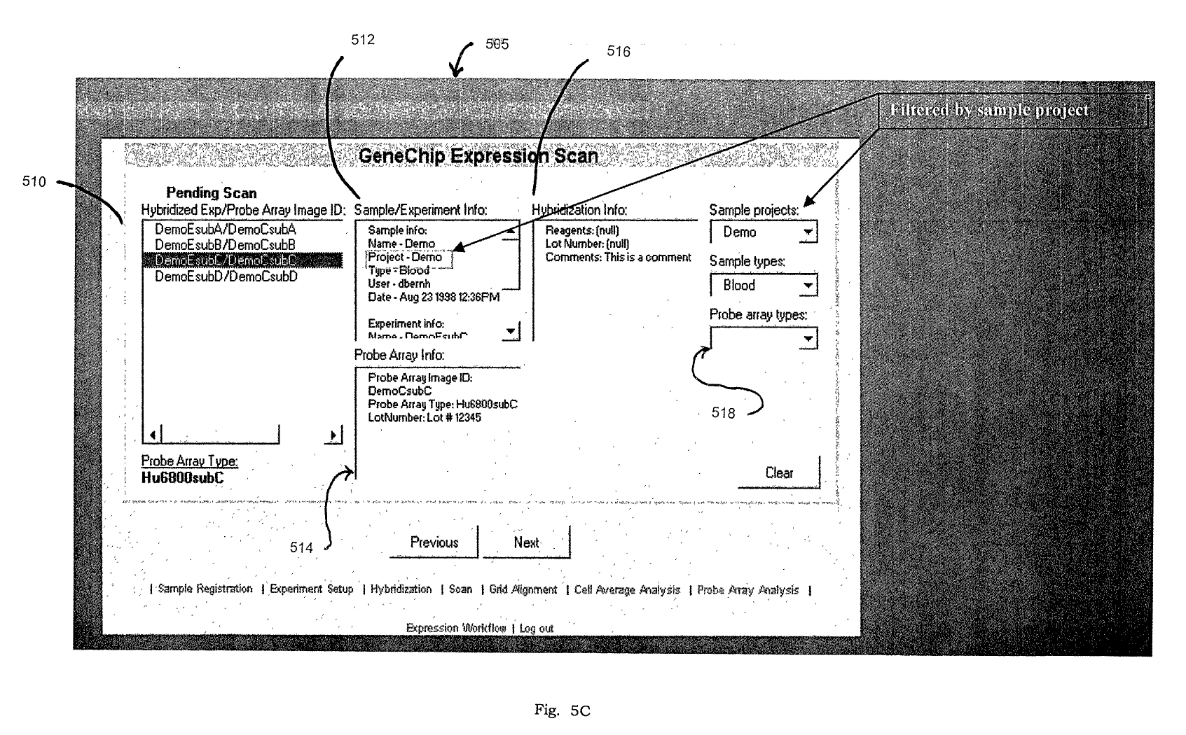

FIG. 5A illustrates a representative automation page in a particular embodiment according to the present invention. This diagram is merely an illustration and should not limit the scope of the claims herein. One of ordinary skill in the art would recognize other variations, modifications, and alternatives. FIG. 5A illustrates an automation page 501 having a sample information section 502 and an experiment information section 504 and a sample experiment probe array section 506. Sample information section 502 provides fields for entering data such as a sample name, a sample type, a project name and a description of the sample and any comments. Fields for entering other data can also be included in various embodiments of the present invention. Experiment information section 504 includes fields for entering experiment name, a probe array image identifier, a probe array type and information about the probe array such as a lot number, an analysis set, a cell average set, as well as a target database for publishing results. Section 506 provides a display for matching sample probe arrays, sample experiments and probe array identifier's. A presently preferable embodiment provides the capability to have multiple samples as well as the capability to have multiple experiments per sample.

FIG. 5B illustrates an automation results page 503 in a particular embodiment according to the present invention. This diagram is merely an illustration and should not limit the scope of the claims herein. One of ordinary skill in the art would recognize other variations, modifications, and alternatives. Automation results page 503 provides a display of a plurality of steps in the setup and execution of an experiment and a result for a particular sample for each of the steps. For example, as illustrated by FIG. 5B, a sample first step entitled, “sample demo past registration” has received a pass result. Other steps can be included in various embodiments without departing from the scope of the claims of the present invention.

FIG. 5C illustrates a representative expression scan screen 505 in a particular embodiment according to the present invention. This diagram is merely an illustration and should not limit the scope of the claims herein. One of ordinary skill in the art would recognize other variations, modifications, and alternatives. FIG. 5C illustrates information about a pending scan. Screen 505 includes a hybridized expression probe array image identifier field 510, which users can use to select particular probe arrays for scanning. A sample in experiment information field 512 provides information about the sample such as its name, a project, the type of sample, the user's identifier and the date, as well as information about the experiment. Probe array information field 514 provides information about the probe array image such as the identifier, the array type and the lot number. Hybridization information field 516 provides information about reagents and lot numbers. A plurality of filter fields 518 provide the capability to filter sample projects, sample types and probe array types.

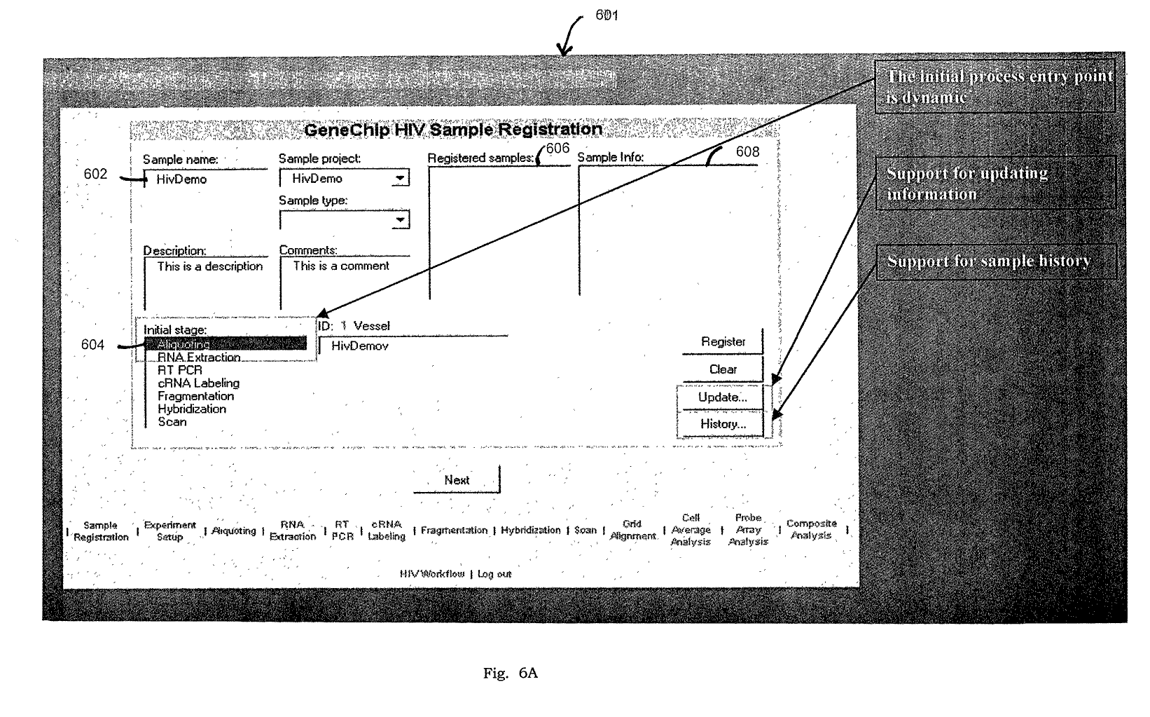

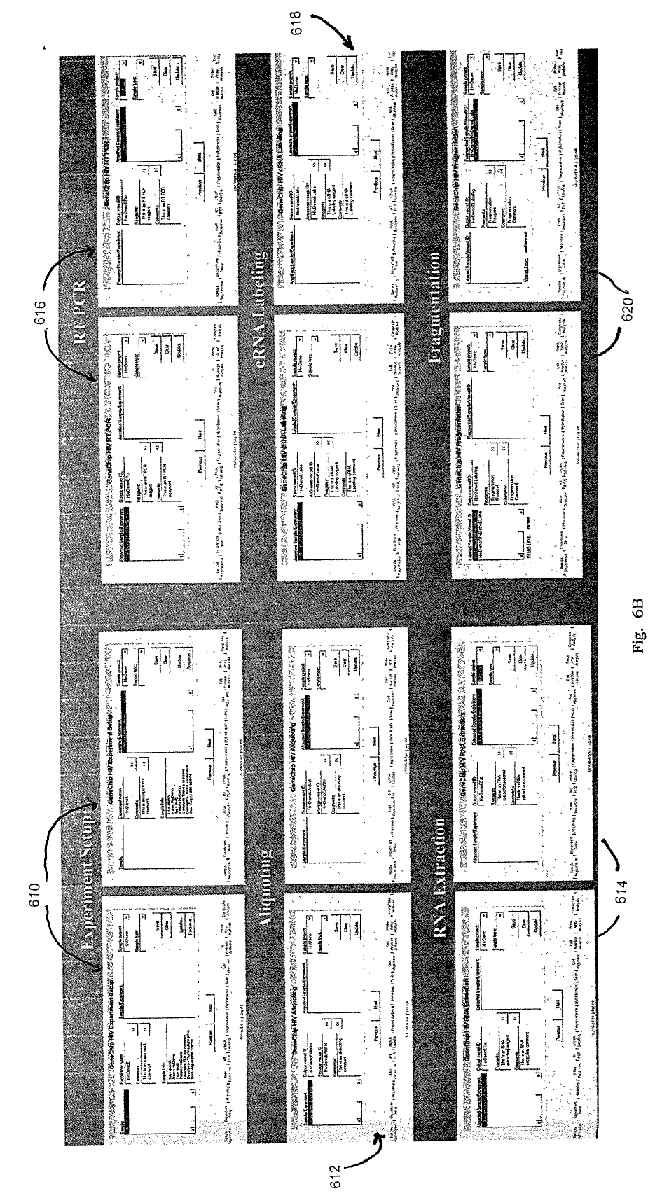

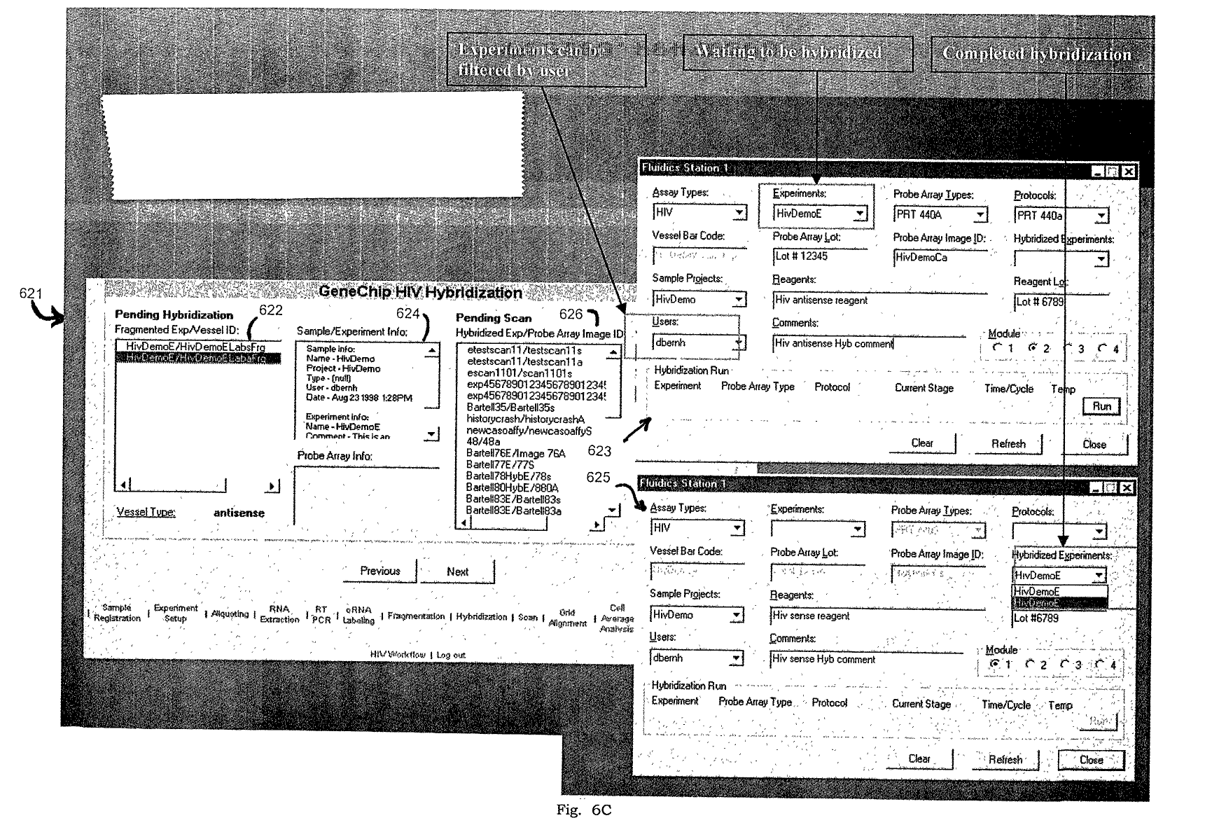

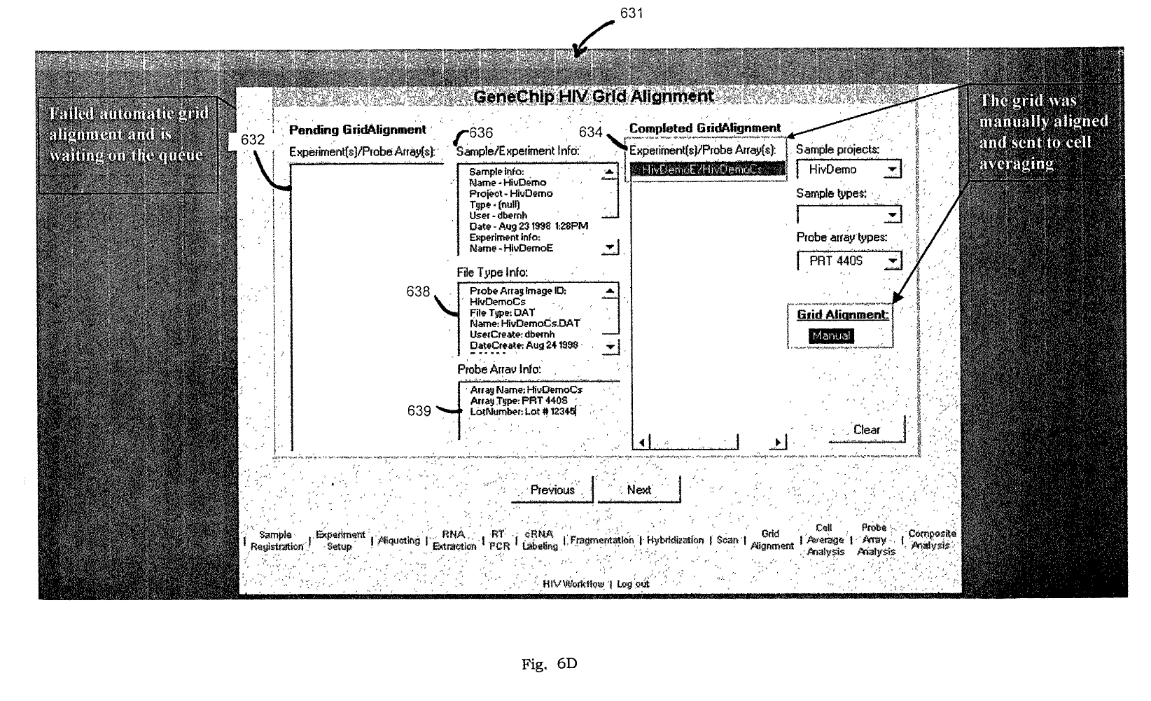

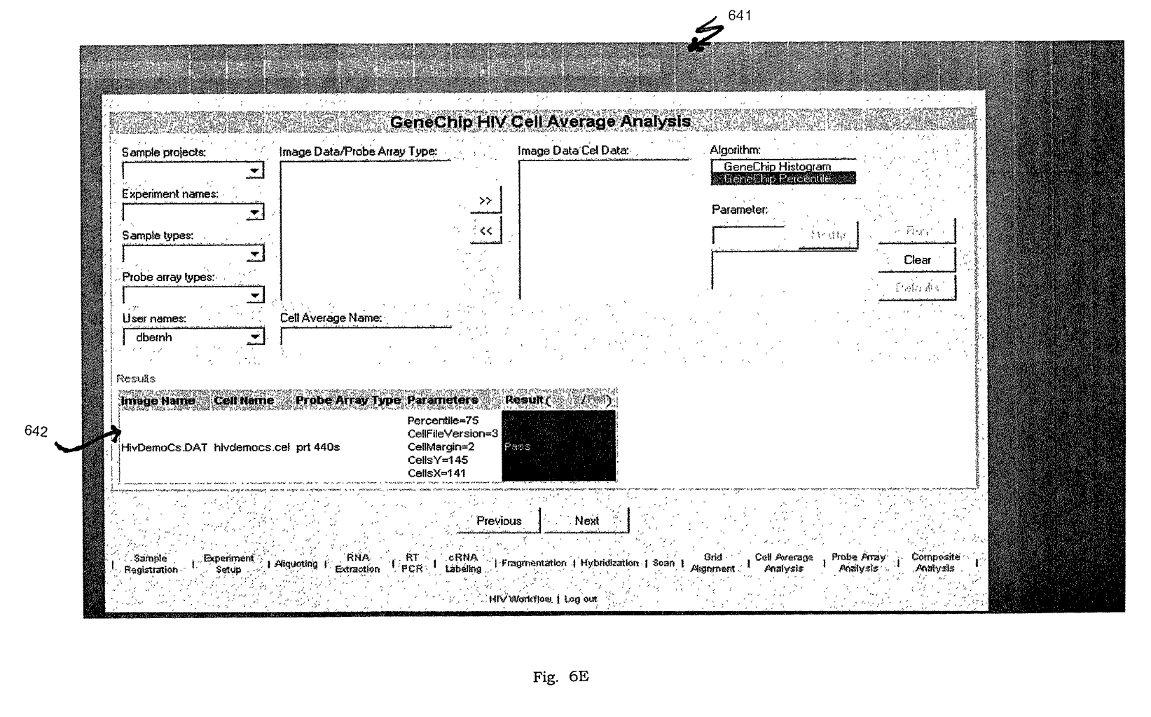

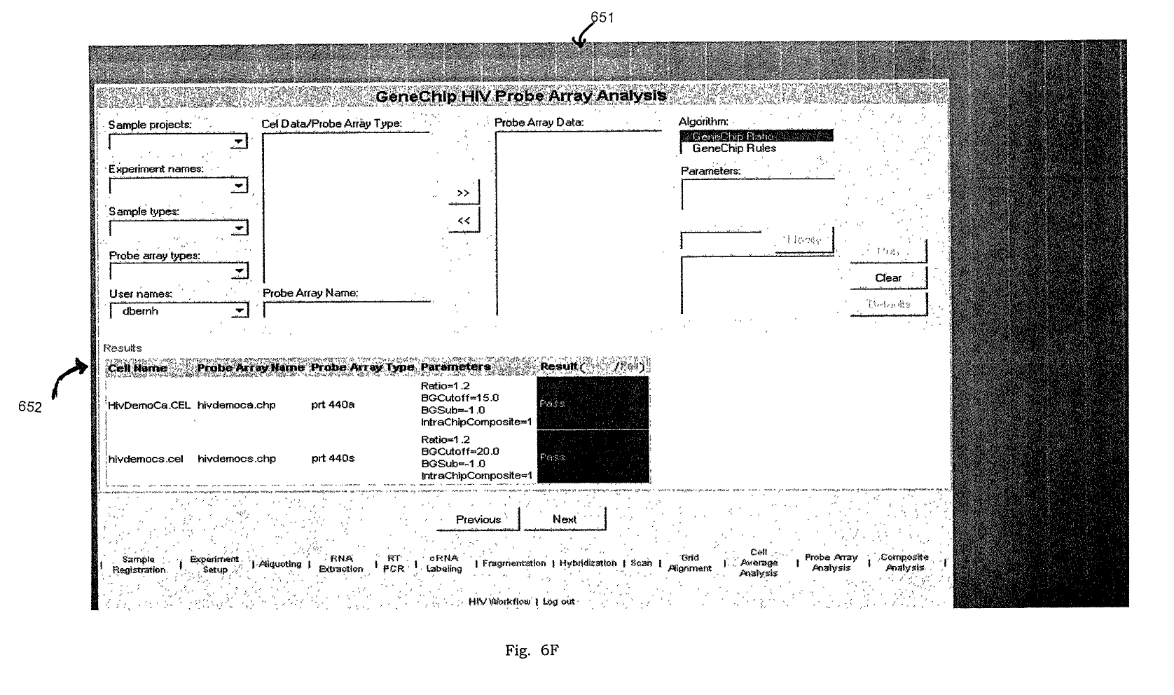

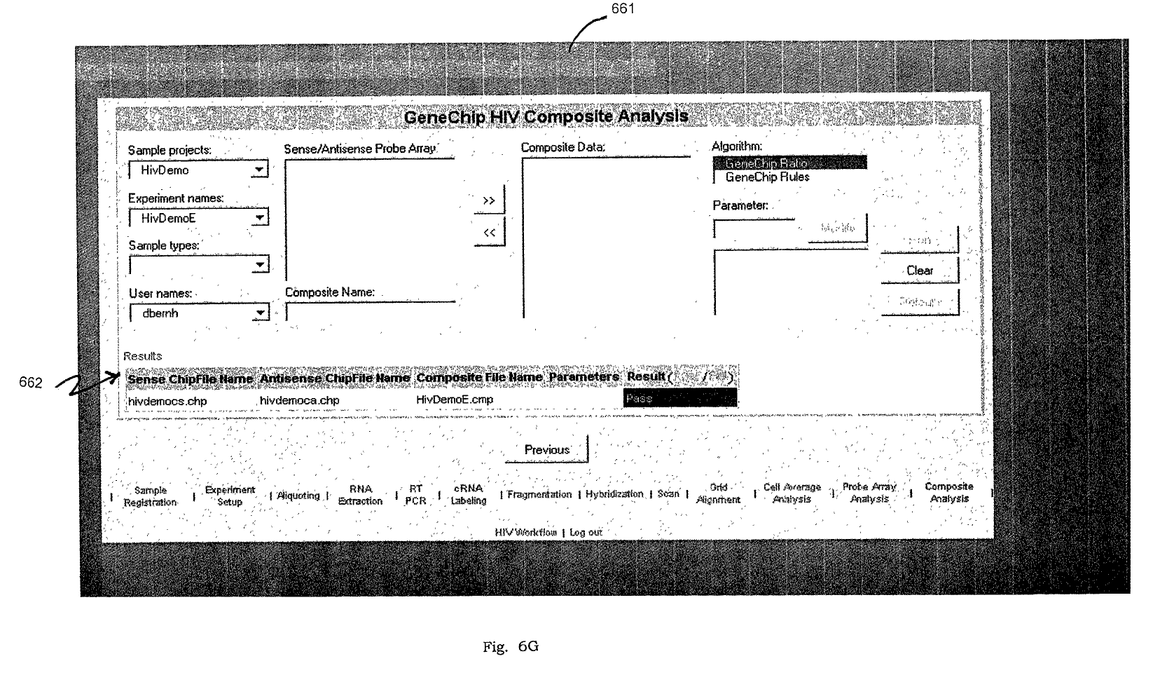

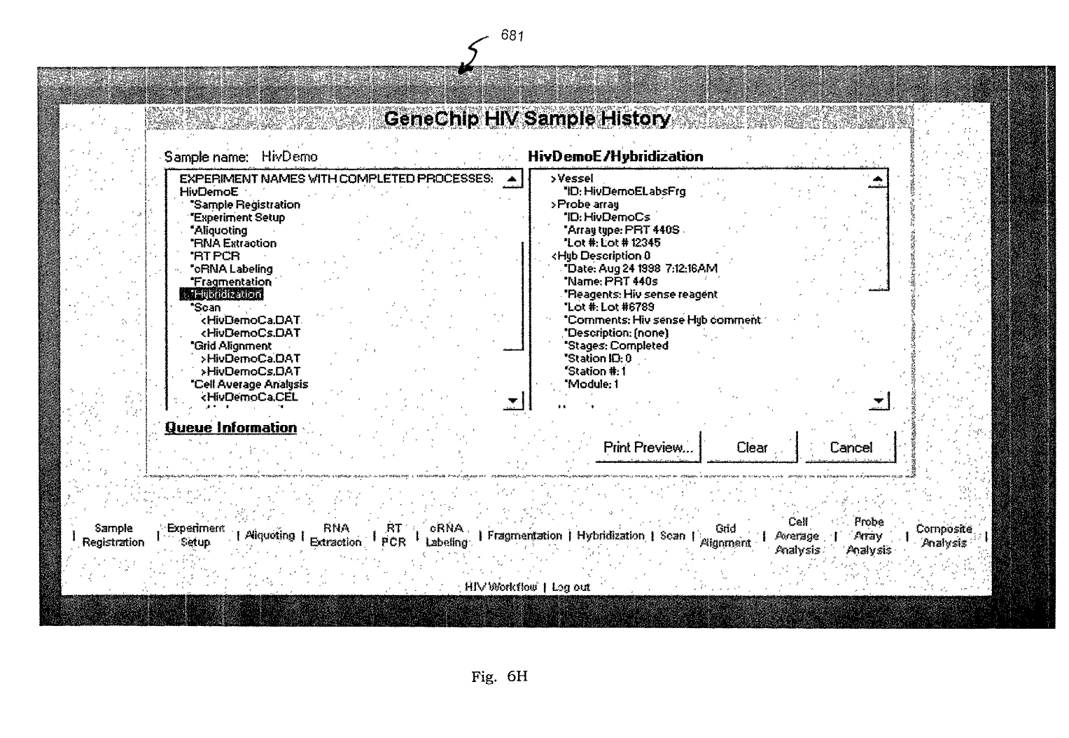

FIG. 6A illustrates a representative sample registration screen in a particular embodiment according to the present invention. This diagram is merely an illustration and should not limit the scope of the claims herein. One of ordinary skill in the art would recognize other variations, modifications, and alternatives. FIG. 6A illustrates sample registration screen 601 having fields for entry of data that describe the sample. For example, screen 601 includes fields for entering a sample name 602, sample project, sample type, as well as comments and description fields. An initial process entry point field 604 enables the user to select a particular point in the laboratory's processes as a starting point. A registered samples field 606 provides a listing of samples that have been registered. A sample information field 608 provides information about the various samples.

FIG. 6B illustrates a plurality of screens before automating laboratory information management in a particular embodiment according to the present invention. This diagram is merely an illustration and should not limit the scope of the claims herein. One of ordinary skill in the art would recognize other variations, modifications, and alternatives. FIG. 6B illustrates screens 610 for performing experiment setup. Screens 612 provide for performing the aliquoting step. Screens 614 provide for performing RNA extraction. Screens 616 provide for performing RT PCR. Screens 618 provide for performing cRNA labeling and screens 620 provide for performing fragmentation. Other screens and different types or designs of screens can be used in various embodiments according to the present invention without departing from the scope of the claims herein.

FIG. 6C illustrates representative hybridization screens in a particular embodiment according to the present invention. This diagram is merely an illustration and should not limit the scope of the claims herein. One of ordinary skill in the art would recognize other variations, modifications, and alternatives. FIG. 6C illustrates a screen 621 for controlling hybridization processes. Screen 621 comprises a pending hybridization fragmented expression vessel identifier field 622. Such hybridization fragmented expression vessels contain samples that have been fragmented. Sample and experiment information field 624 provides tracking information about samples and experiments in the hybridization process. Pending scan fields 626 provide hybridized expression and probe array image identification information. FIG. 6C also illustrates hybridization control screen 623 and hybridization control screen 625. Screen 623 provides information about an experiment waiting to undergo the hybridization step. Screen 625 provides information about an experiment that has completed the hybridization step.

FIG. 6D illustrates grid alignment control screens in a particular embodiment according to the present invention. This diagram is merely an illustration and should not limit the scope of the claims herein. One of ordinary skill in the art would recognize other variations, modifications, and alternatives. FIG. 6D illustrates a grid alignment control screen 631. Grid alignment control screen 631 comprises a pending grid alignment display area 632 as well as a completed grid alignment display area 634. A sample experiment information field fields 636 provide information about samples and experiments in the grid alignment process. File type information field 638 provides identification information about the file type, and a probe array information field 639 provides identification information about the probe array.

FIG. 6E illustrates a representative cell average analysis screen in a particular embodiment according to the present invention. This diagram is merely an illustration and should not limit the scope of the claims herein. One of ordinary skill in the art would recognize other variations, modifications, and alternatives. FIG. 6E illustrates screen 641 having a plurality of fields for entering information about sample projects, experiment names, sample types, probe array types, user names, image data/ probe array type, cell average name, image data and cell data, algorithm and other parameters. Further, a results area 642 provides information for a particular image name, a cell name, a probe array type and various parameters. A results area provides a pass/fail indication for the particular experiment.

FIG. 6F illustrates a representative probe array analysis screen in a particular embodiment according to the present invention. This diagram is merely an illustration and should not limit the scope of the claims herein. One of ordinary skill in the art would recognize other variations, modifications, and alternatives. FIG. 6F illustrates screen 651 having a plurality of fields for entering information about sample projects, experiment names, sample types, probe array types, user names, cell data/probe array type, probe array name, probe array data, algorithm and other parameters. FIG. 6F also illustrates a results area 652 having a cell name, a probe array name, a probe array type, a parameters area and a results area for providing a pass/fail indication.

FIG. 6G illustrates a composite analysis screen in a particular embodiment according to the present invention. This diagram is merely an illustration and should not limit the scope of the claims herein. One of ordinary skill in the art would recognize other variations, modifications, and alternatives. FIG. 6G illustrates a screen 661 having a plurality of fields for entering information about sample projects, experiment names, sample types, user names, sense/anti-sense probe array, composite name, composite data, algorithm and other parameters. Additionally, screen 661 provides a results area 662 for displaying a sense chip file name, anti-chip file name, composite file name, a parameters area and a results area for providing a pass/fail indication of results.

FIG. 6H provides a representative sample history screen in a particular embodiment according to the present invention. This diagram is merely an illustration and should not limit the scope of the claims herein. One of ordinary skill in the art would recognize other variations, modifications, and alternatives. Simple history screen 681 provides a historical listing of processes which have completed with respect to a particular sample.

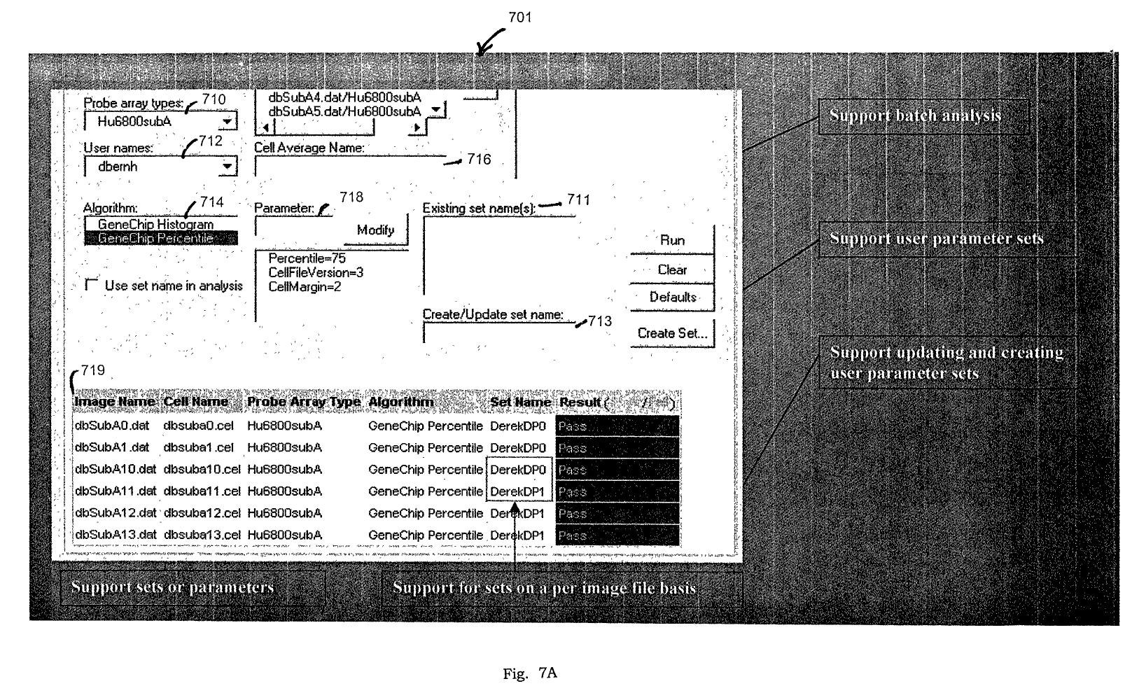

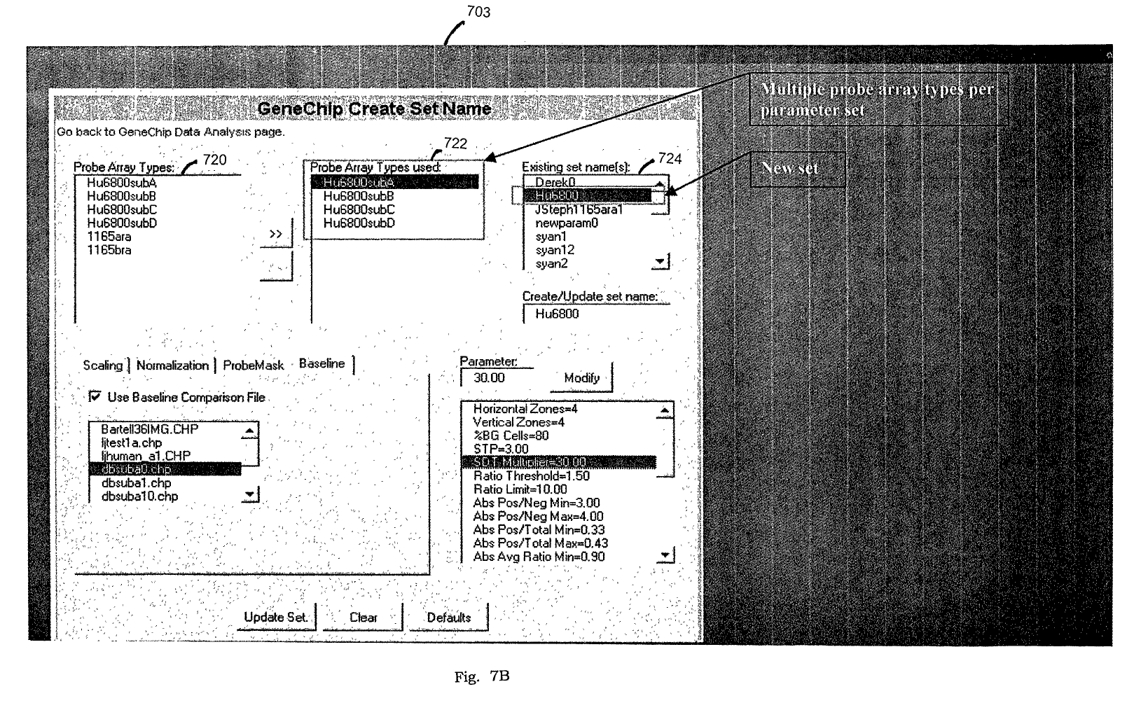

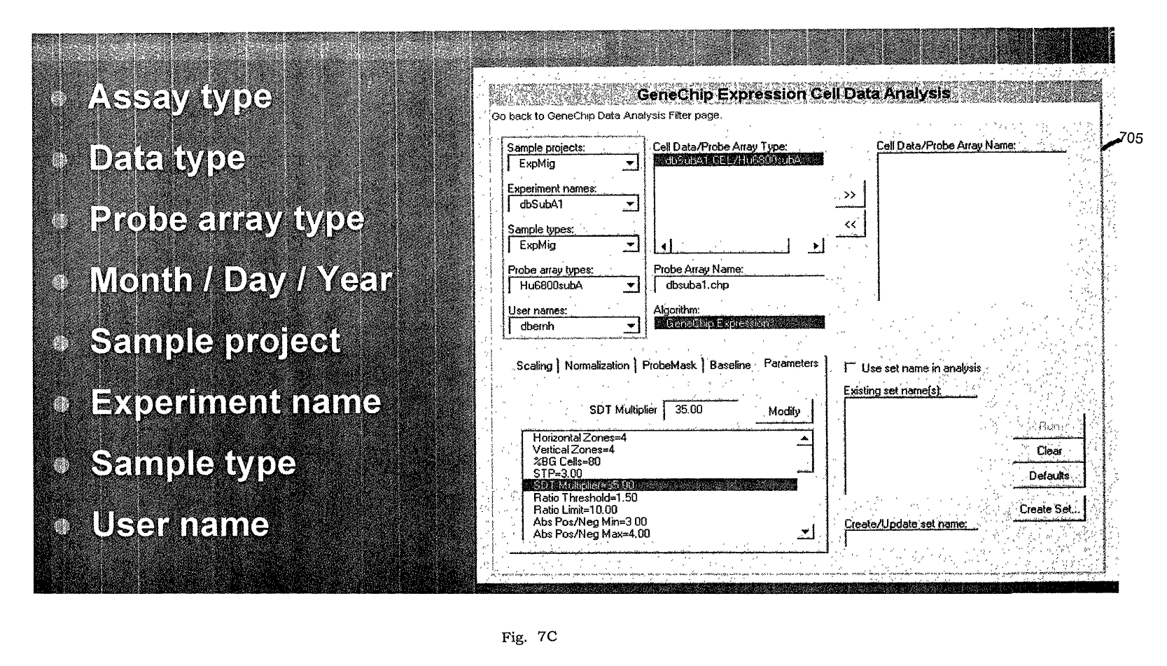

FIG. 7A illustrates a representative expression analysis screen for working with sets in a particular embodiment according to the present invention. This diagram is merely an illustration and should not limit the scope of the claims herein. One of ordinary skill in the art would recognize other variations, modifications, and alternatives. FIG. 7A illustrates screen 701 having a plurality of fields including a probe array type field 710, a user name field 712, an algorithm field 714, cell average name field 716, parameter field 718, existing set name field 711, a create update set name field 713, and a results area 719. The results area provides fields for image name, cell name, probe array type, algorithm, set name and an area for indicating a pass/fail result for the expression analysis step. Some embodiments can provide support for batch analysis of experimental results and user parameter sets.

FIG. 7B illustrates a create set name screen in a particular embodiment according to the present invention. This diagram is merely an illustration and should not limit the scope of the claims herein. One of ordinary skill in the art would recognize other variations, modifications, and alternatives. FIG. 7B illustrates a screen 703 having a probe array type field 720, a probe array types used field 722, an existing set names field 724, and an area for specifying scaling and normalizations for various chips.

FIG. 7C illustrates an expression cell data analysis screen in a particular embodiment according to the present invention. This diagram is merely an illustration and should not limit the scope of the claims herein. One of ordinary skill in the art would recognize other variations, modifications, and alternatives. FIG. 7C illustrates screen 705 having a plurality of fields for describing filter parameters. Filtering can be performed on a number of fields such as the assay type, data type, probe array type, date; including month, day and year, sample project, experiment name, sample type, user name and others.

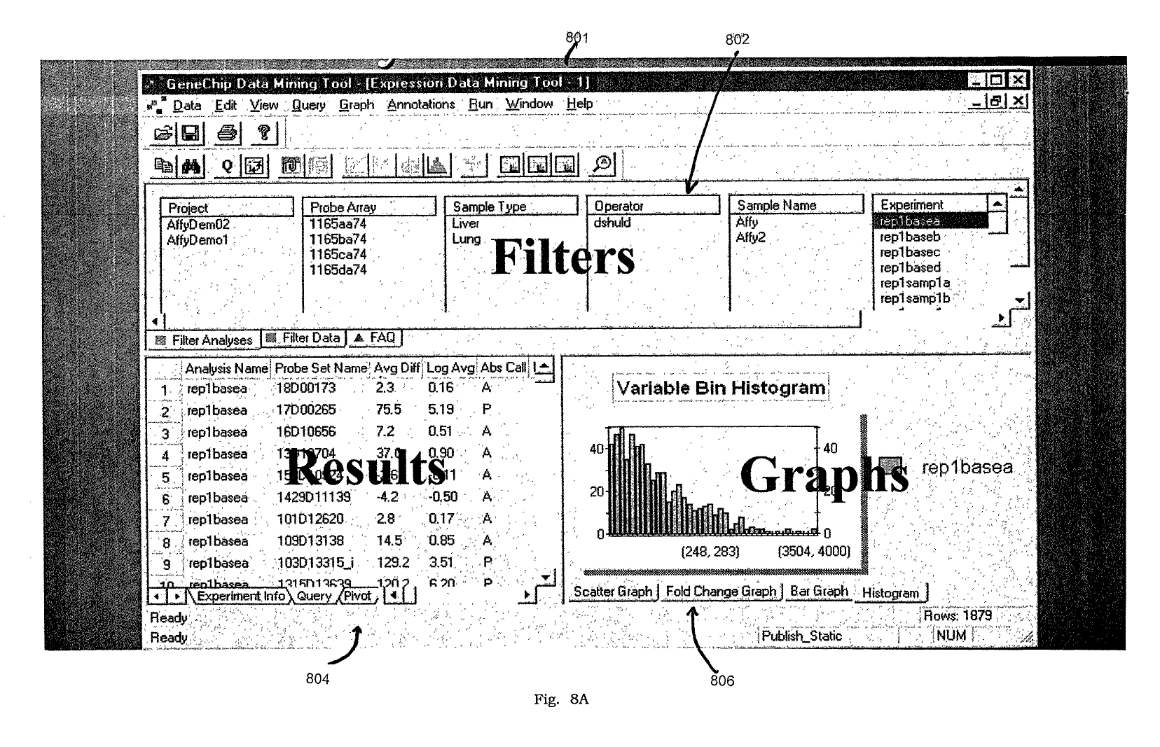

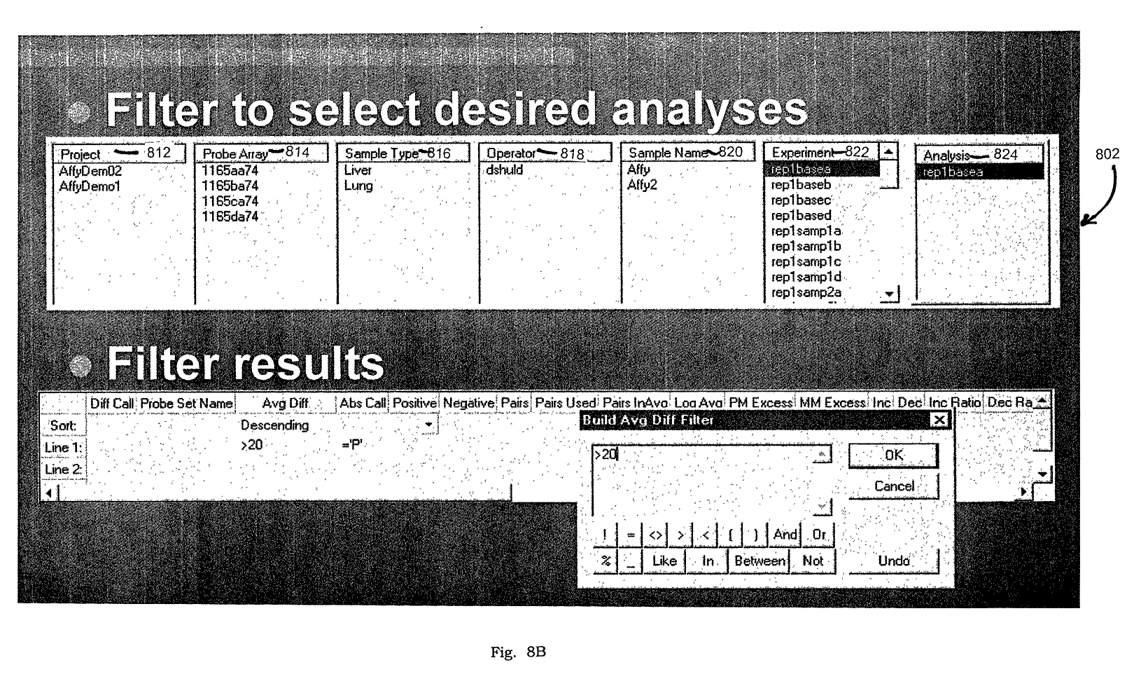

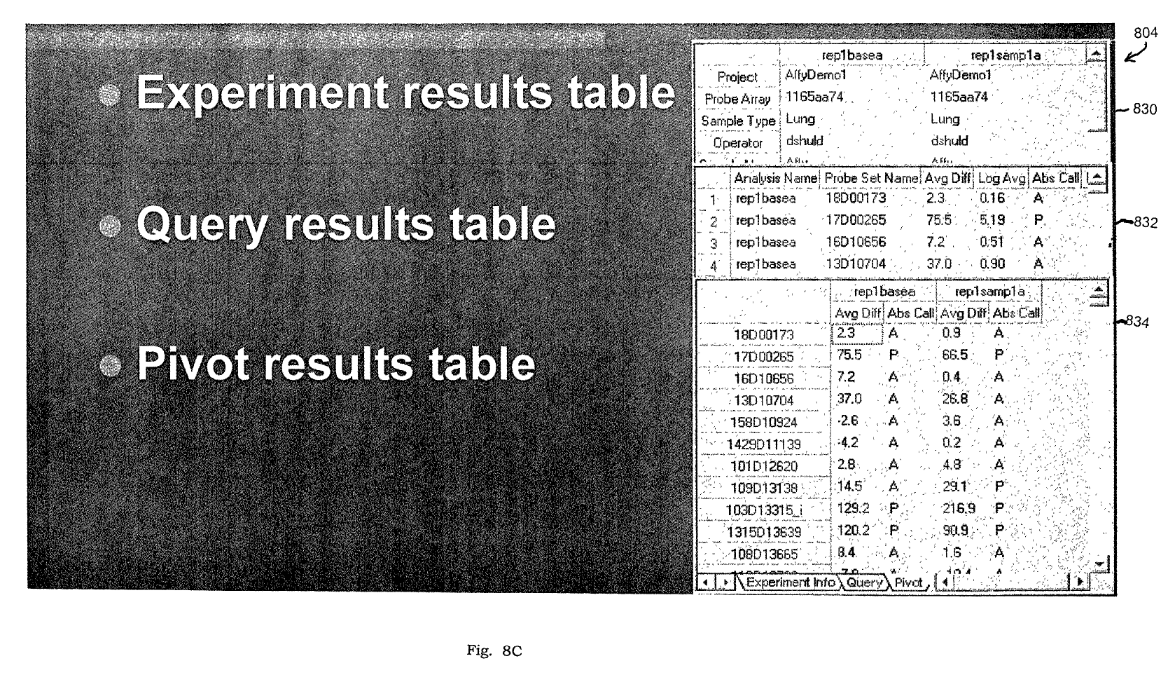

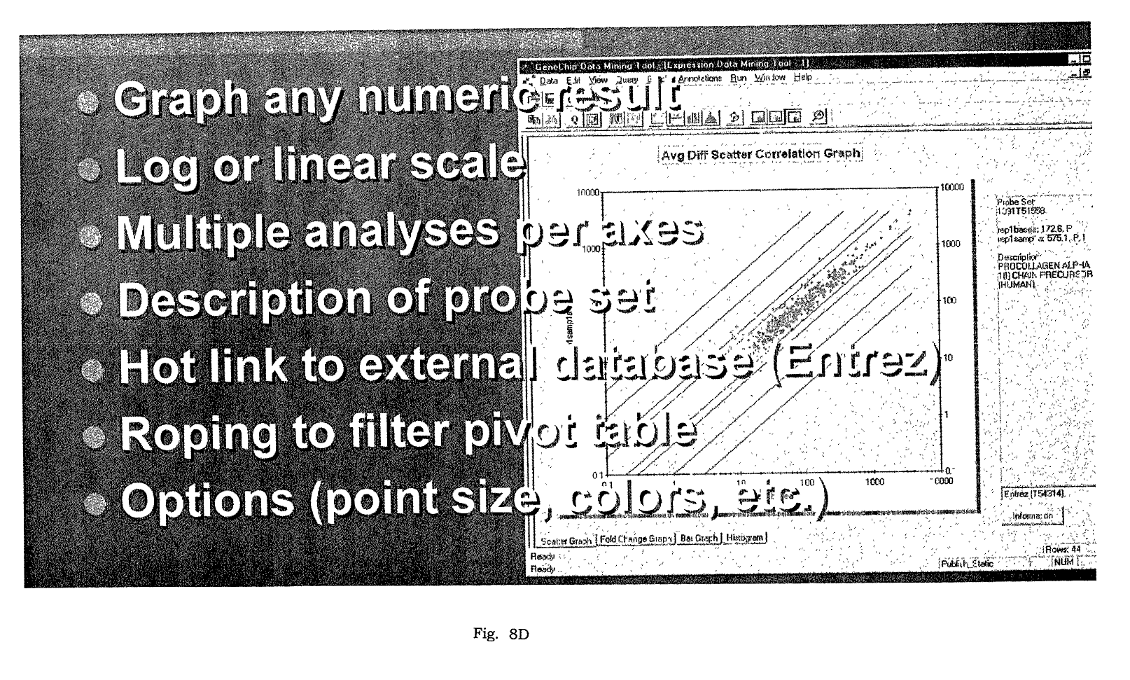

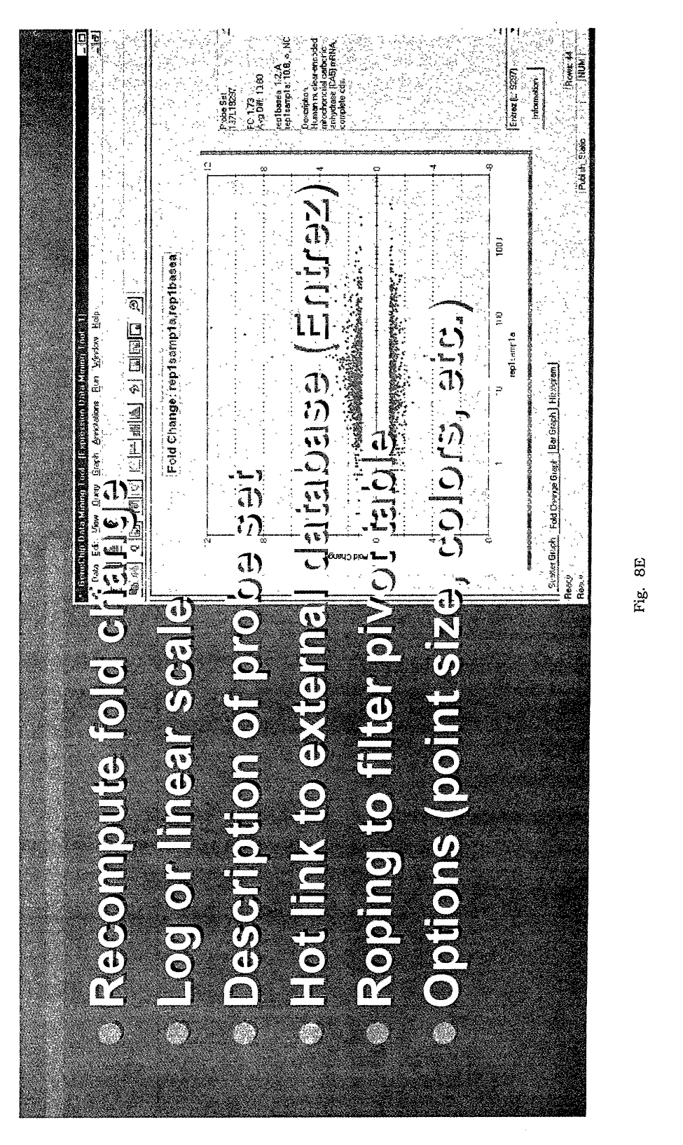

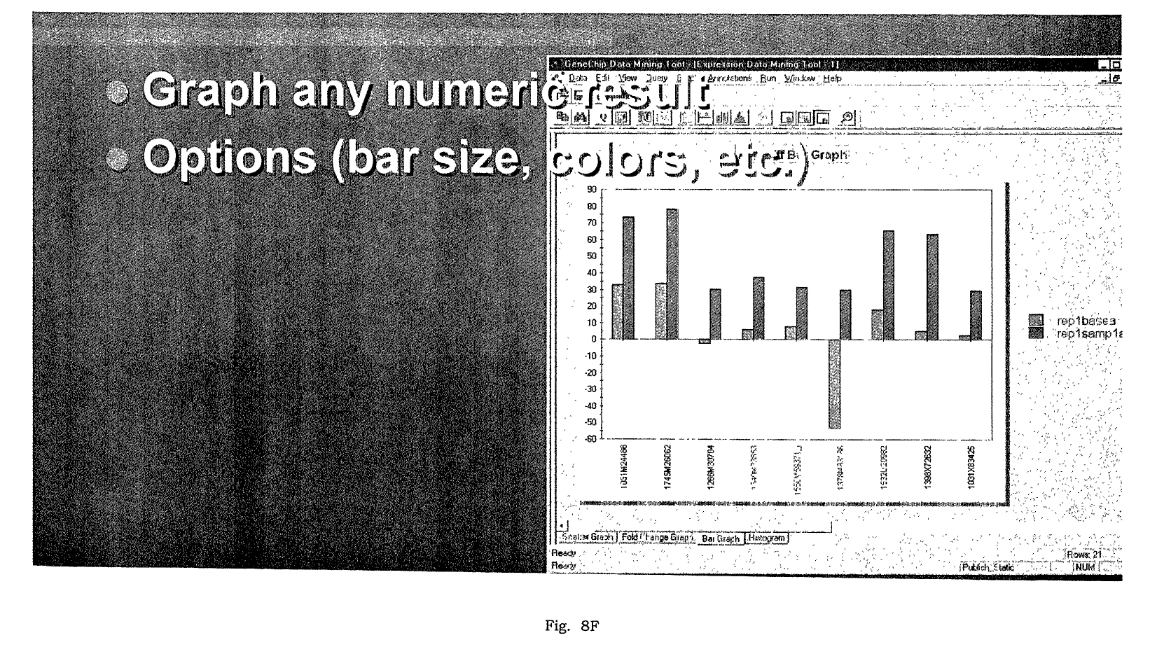

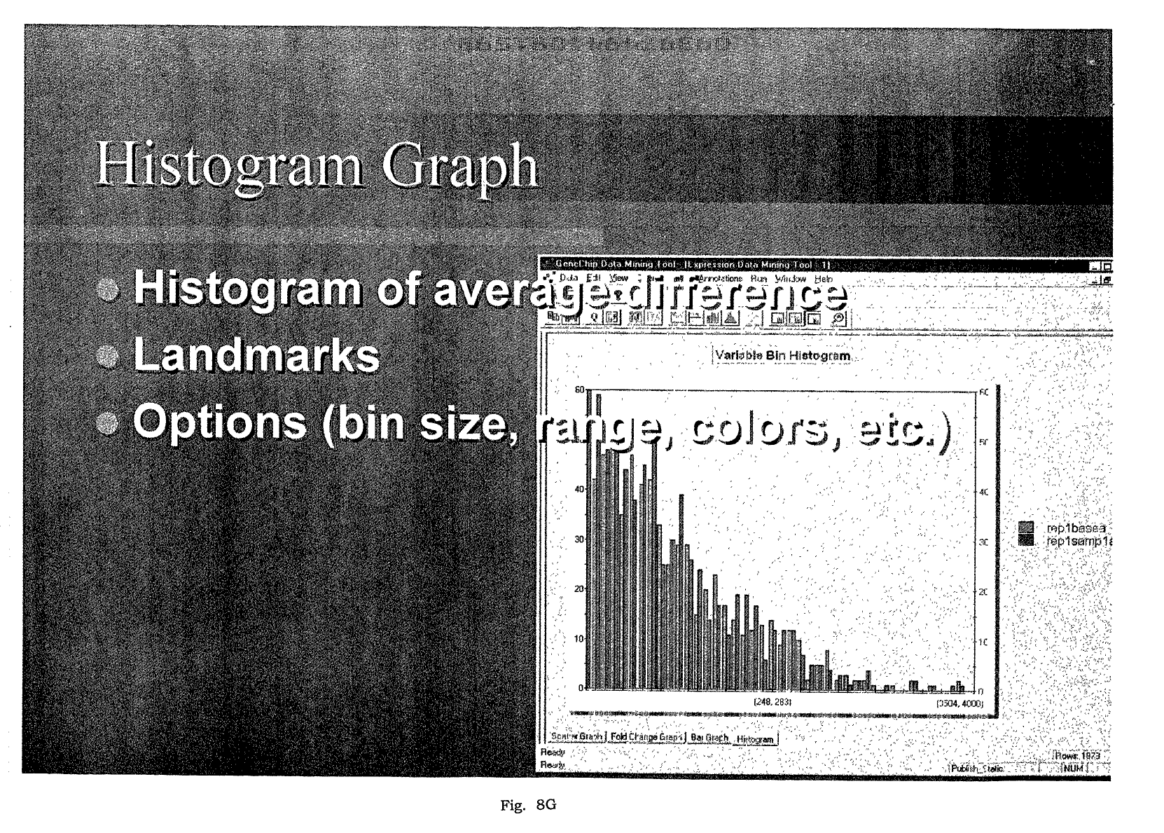

FIGS. 8A-8C illustrate representative Expression Data Mining Tool (EDMT) screens in a particular embodiment according to the present invention. These diagrams are merely illustrations and should not limit the scope of the claims herein. One of ordinary skill in the art would recognize other variations, modifications, and alternatives. FIG. 8A illustrates an EDMT screen 801. Screen 801 comprises a plurality of areas, such as an area 802 that provides information about filters. Filters can be applied to the experimental data to narrow down the field of data on which to mine. A results area 804 provides results of the filter data. A graphs area 806 provides a plurality of formats of graphs for viewing the data.

FIG. 8B illustrates a filter area such as filter area 802 of FIG. 8A in a particular embodiment according to the present invention. FIG. 8B illustrates filter area 802 having fields for a project filter 812, a probe array filter 814, a sample-type filter 816, an operator filter 818, a sample name filter 820, an experiment filter 822 and an analysis filter 824. FIG. 8B also illustrates a filter results field for illustrating the type of filters being applied to the data. Queries can be described using the filters of filter area 802. In a presently preferable embodiment, a user can select the analyses to query and then select the ranges on the results.

FIG. 8C illustrates a results area such as results area 804 of FIG. 8A in a particular embodiment according to the present invention. FIG. 8C illustrates results area 804 having an experimental results table 830 and query results table 832 and a pivot results table 834.

FIGS. 8D-8G illustrate representative graphs such as can be displayed in graph section 806 of FIG. 8A in a particular embodiment according to the present invention. These diagrams are merely illustrations and should not limit the scope of the claims herein. One of ordinary skill in the art would recognize other variations, modifications, and alternatives. FIG. 8D illustrates a scatter-type graph of experimental results. The scatter graph can graph any numeric result on a logarithmic or linear scale. Further, a presently preferable embodiment can provide the capability to have multiple analyses per axes. A description of the probe set is included on the right side of the graph. A hotlink to external databases can also be provided at least in the preferred embodiment according to the present invention. Other options such as filters, point sizes, colors and the like can be specified by the user.

FIG. 8E illustrates a fold change graph that can be displayed in graph area 806 of FIG. 8A in a particular embodiment according to the present invention. Full change graph of FIG. 8E can be provided using logarithmic or linear scales, the capability to provide a probe set description hotlinks to external data bases and recompute fold change can also be provided by particular embodiments according to the present invention. Further, users can specify options such as point sizes, colors and the like.

FIG. 8F illustrates a representative bar graph such as can be displayed in graph area 806 of FIG. 8A in a particular embodiment according to the present invention. The bar graph of FIG. 8F can graph any numeric result and embodiments can provide the capability to users to change options such as bar size, colors and the like.

FIG. 8G illustrates a representative histogram graph such as can be displayed in graph area 806 of FIG. 8A. The histogram graph of FIG. 8G provides the ability to histogram average differences to indicate various landmarks and can provide the user with the capability to specify options such as pin size, range, colors and the like.

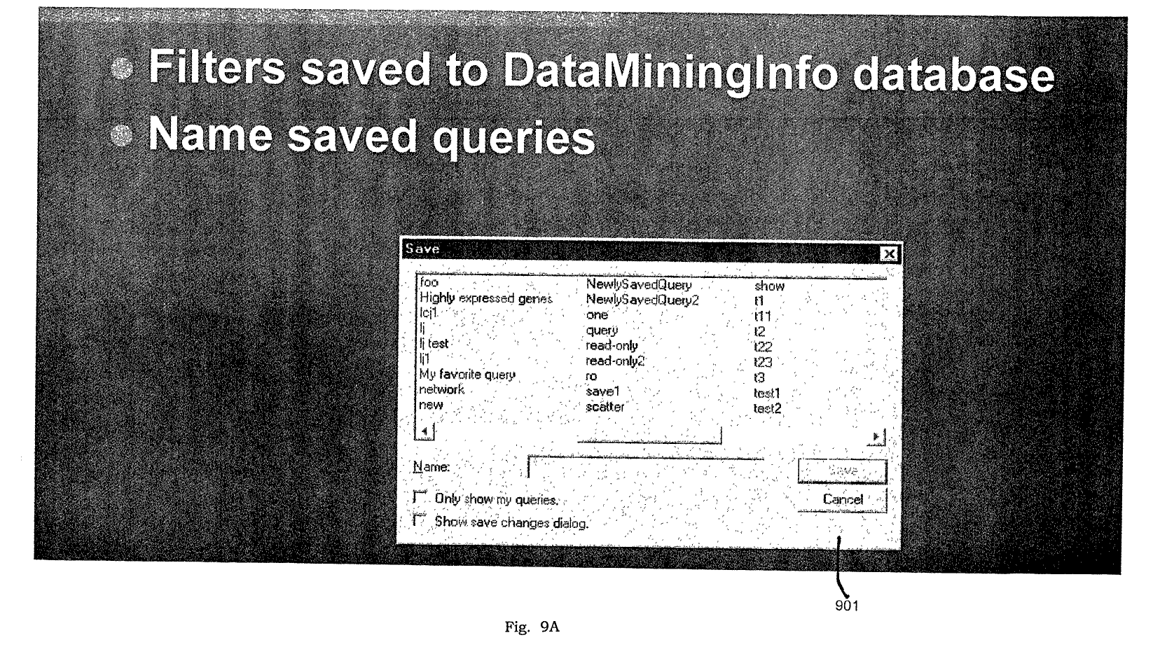

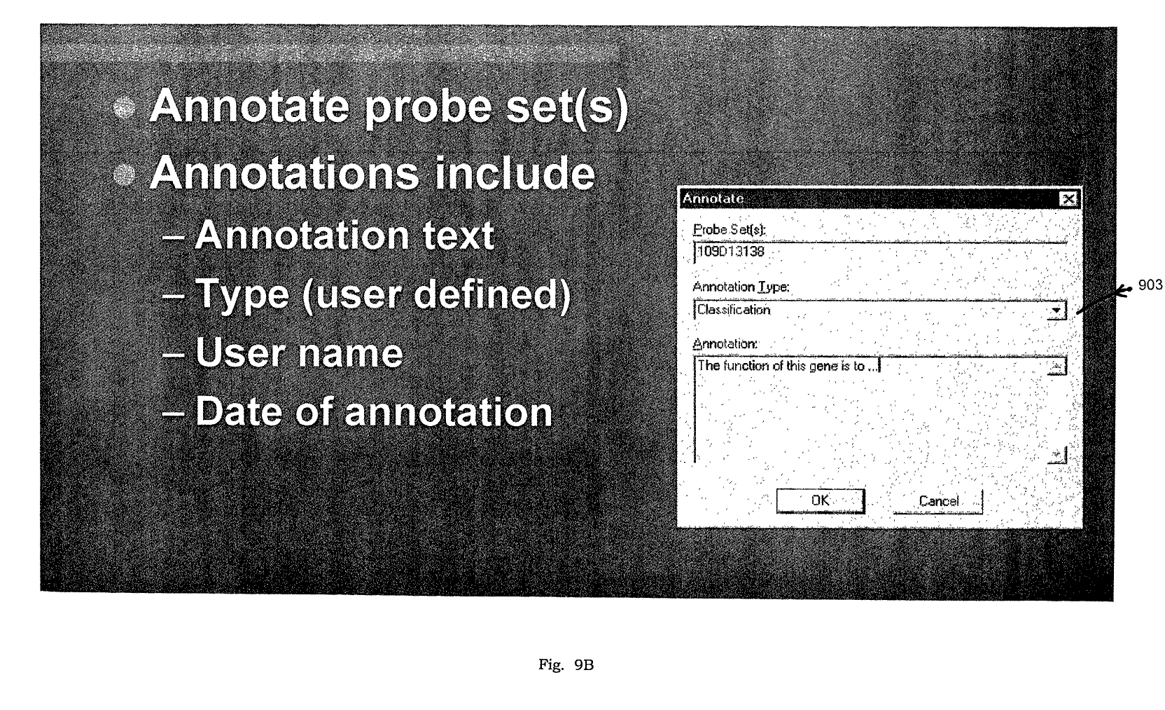

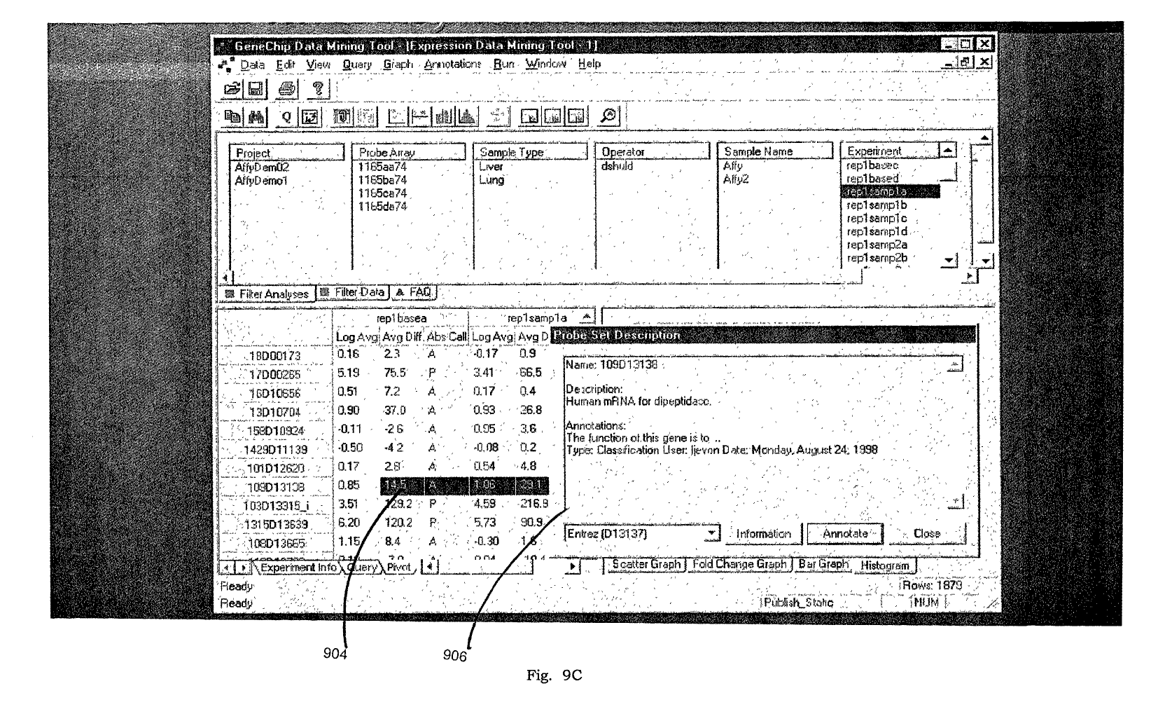

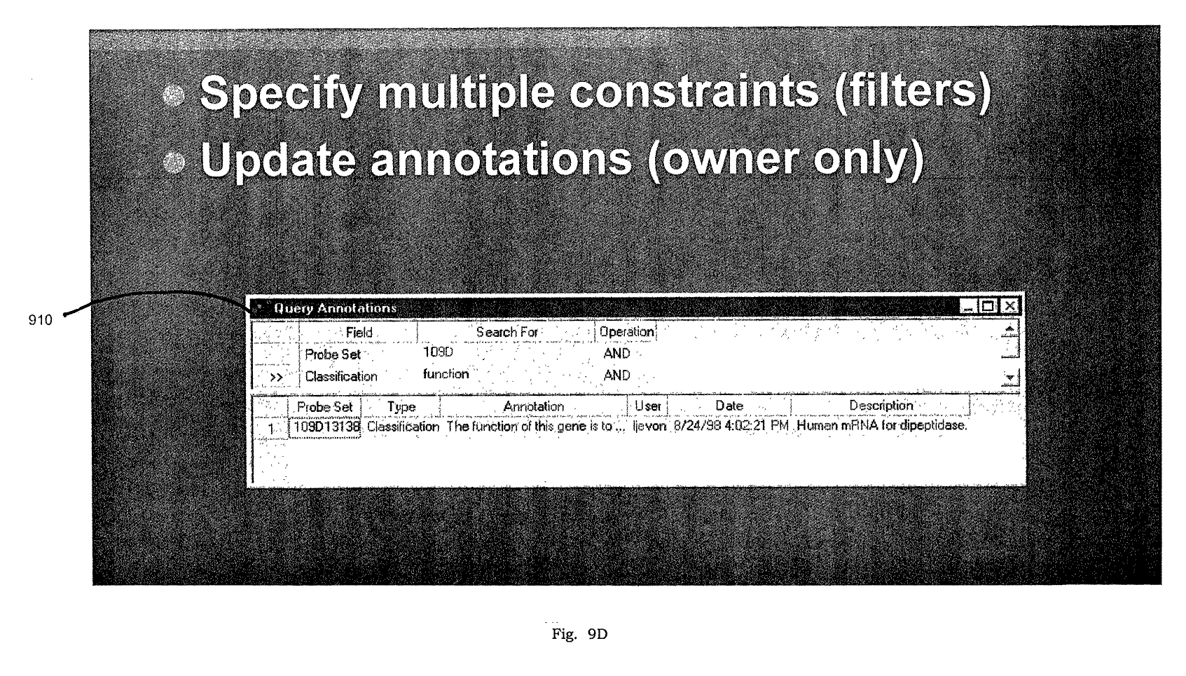

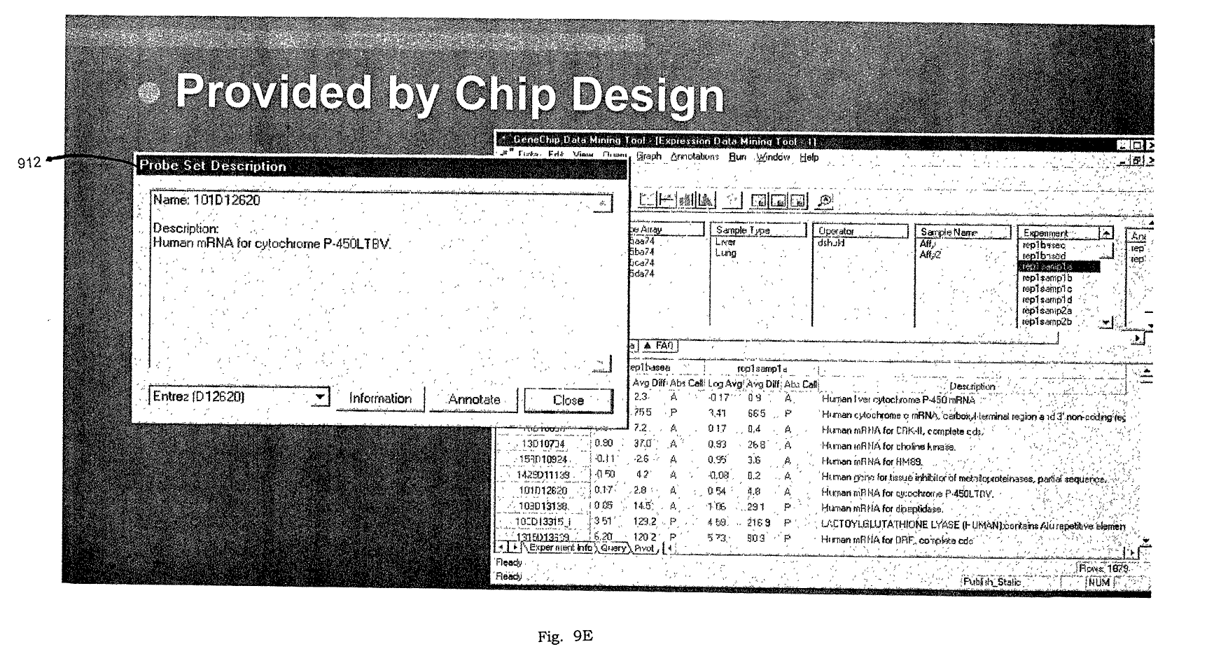

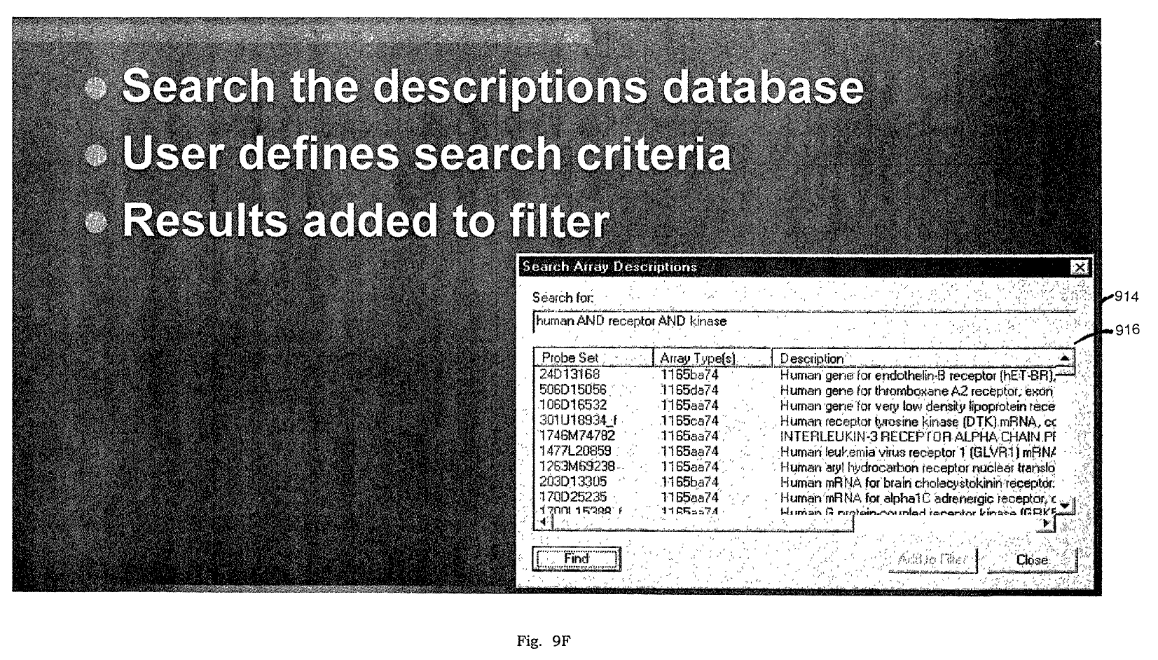

FIG. 9A illustrates a queries display screen in a particular embodiment according to the present invention. This diagram is merely an illustration and should not limit the scope of the claims herein. One of ordinary skill in the art would recognize other variations, modifications, and alternatives. FIG. 9A illustrates name saved queries screen 901 having a display area for a plurality of filters. Users can define filters to the system and save them along with a reference name, that is displayed by screen 901. Filters can be saved to data mining information database 304 for later use.

FIG. 9B illustrates an annotation screen 903 in a particular embodiment according to the present invention. This diagram is merely an illustration and should not limit the scope of the claims herein. One of ordinary skill in the art would recognize other variations, modifications, and alternatives. Annotation screen 903 provides a mechanism for displaying information about a probe set. Annotations can include an annotation text, a type of the annotation as well as other useful information. Annotation types can be user defined in a preferred embodiment. A user name can also be specified and a date can be specified. Other information can be specified in some embodiments and not all of this information will be specified in some embodiments.

FIG. 9C illustrates an example of displaying a probe annotation such as was configured in annotation screen 903 of FIG. 9B in a particular embodiment according to the present invention. This diagram is merely an illustration and should not limit the scope of the claims herein. One of ordinary skill in the art would recognize other variations, modifications, and alternatives. FIG. 9C illustrates a highlighted line of information 904 for which a corresponding probe annotation 906 is displayed. The probe annotation can provide the name of the probe, a description and other useful information.

FIG. 9D illustrates a query annotation screen in a particular embodiment according to the present invention. This diagram is merely an illustration and should not limit the scope of the claims herein. One of ordinary skill in the art would recognize other variations, modifications, and alternatives. FIG. 9D illustrates query annotation screen 910 having fields to specify probe sets types, annotations, a user identifier, a date, and a description. Query annotations can provide the ability to specify multiple filters and can also provide the ability to update annotations.

FIG. 9E illustrates a probe set description screen in a particular embodiment according to the present invention. This diagram is merely an illustration and should not limit the scope of the claims herein. One of ordinary skill in the art would recognize other variations, modifications, and alternatives. FIG. 9E illustrates probe set description screen 912 having the name of a probe set and an associated description. These descriptions can also be displayed in the expression data mining tool screen 801 under the results section 804.

FIG. 9F illustrates a search screen for searching array descriptions in a particular embodiment according to the present invention. This diagram is merely an illustration and should not limit the scope of the claims herein. One of ordinary skill in the art would recognize other variations, modifications, and alternatives. FIG. 9F illustrates search array descriptions screen 914 having an search field 916 for accepting input, and an output field 918 for displaying the probe sets which match the text entered in the input field for the description of the probe set. Search array descriptions screen 914 provides users with the capability to search descriptions in the database. The user can define the search criteria using the input field and can add the results to various filters.

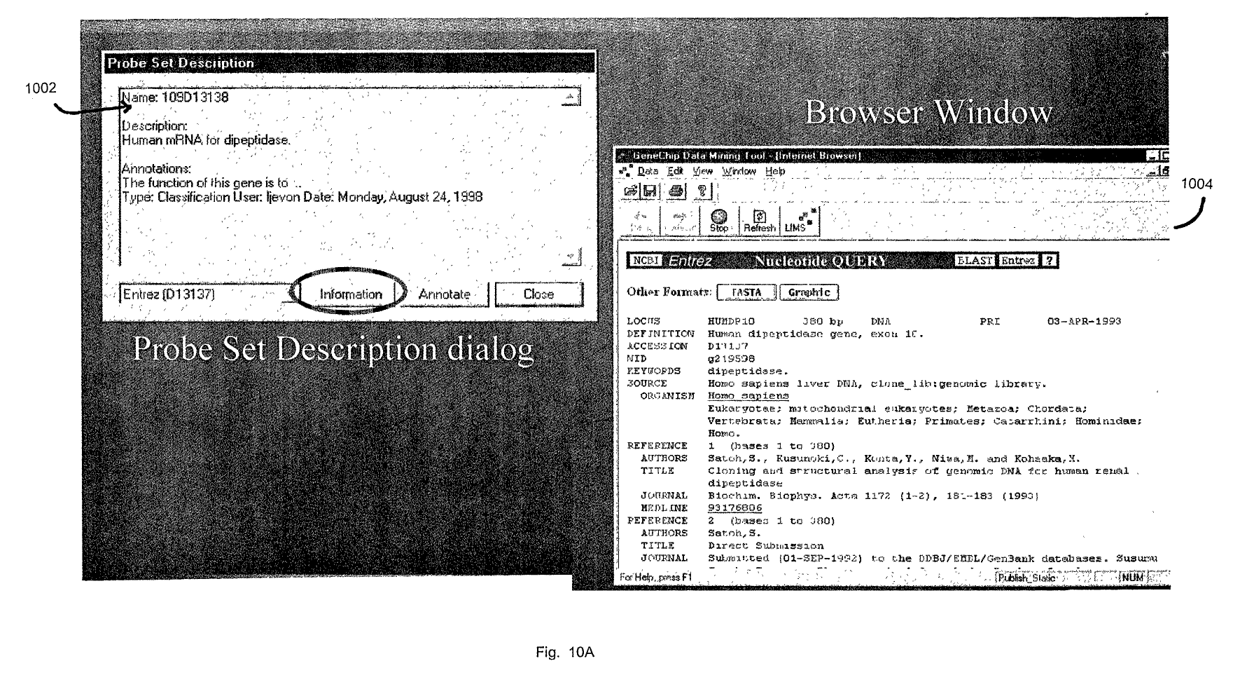

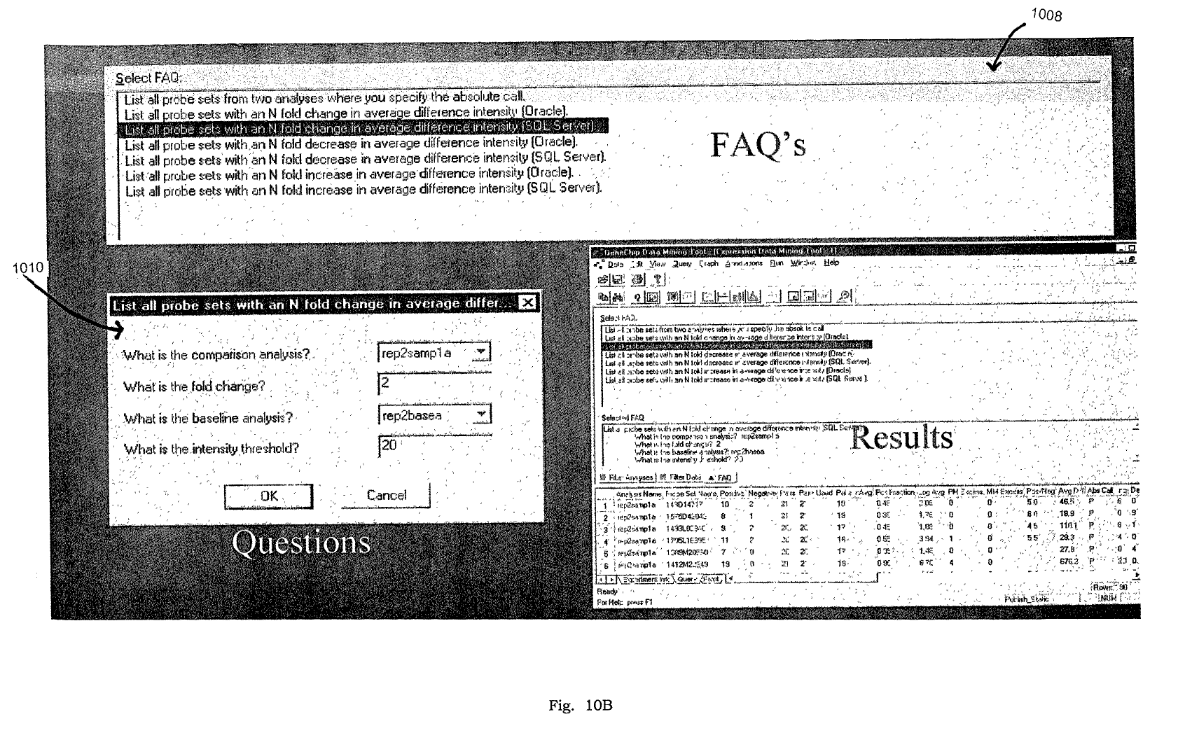

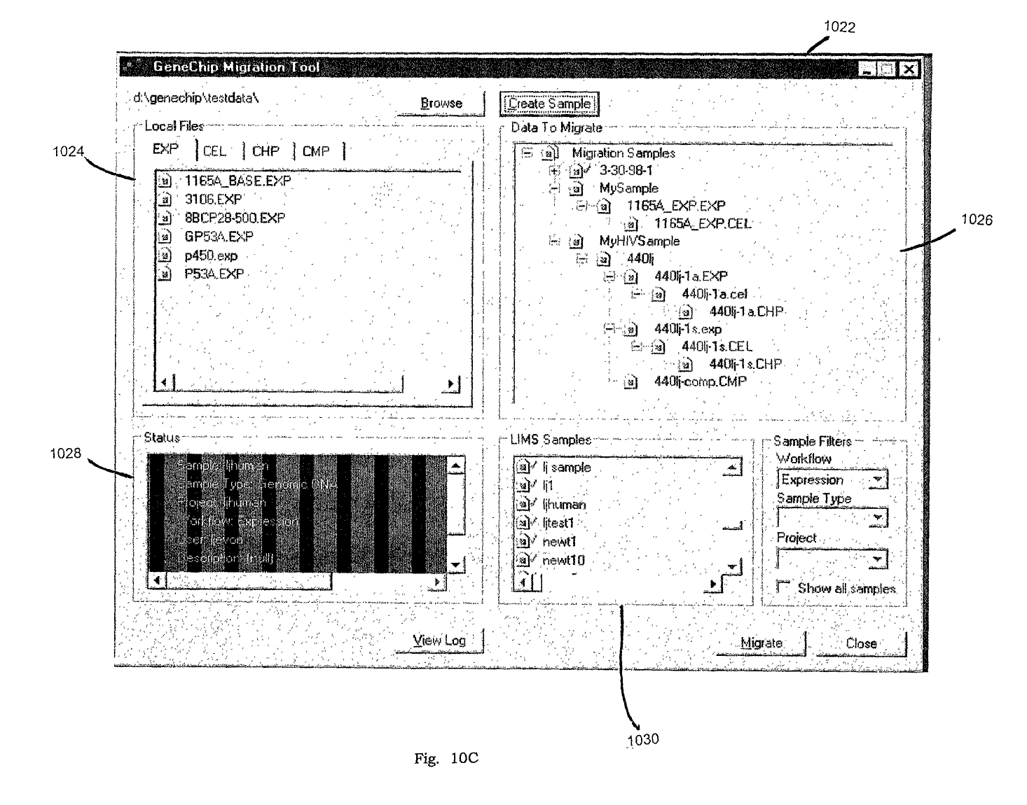

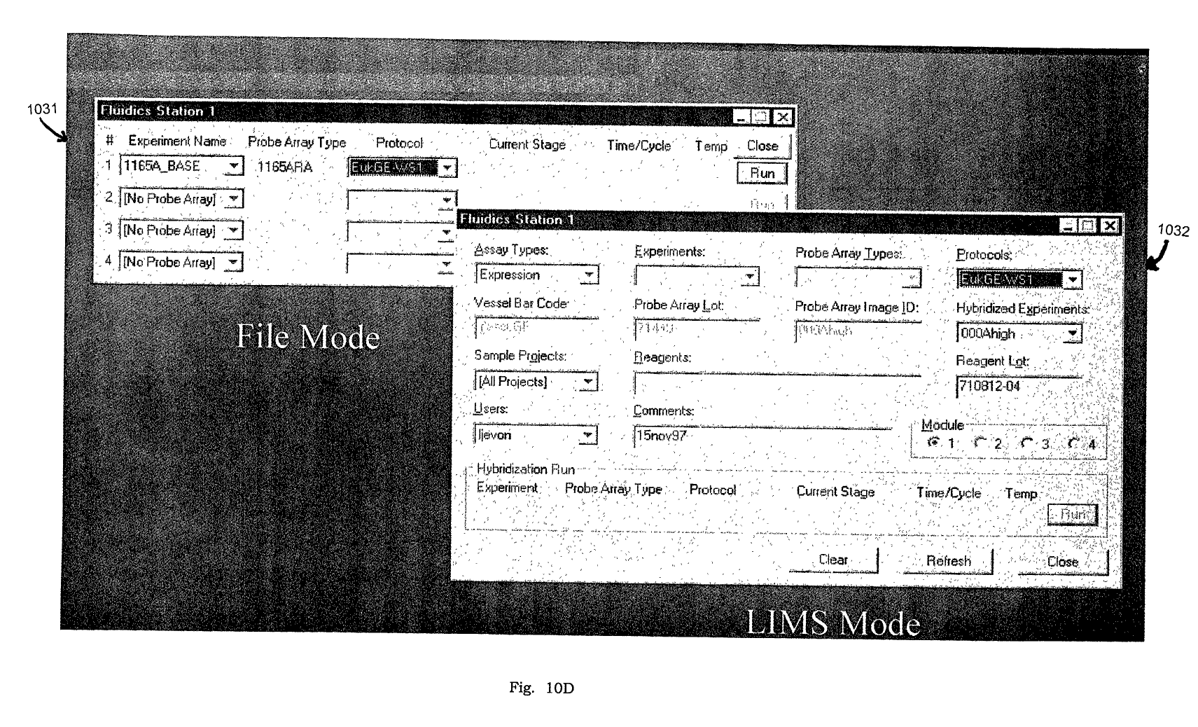

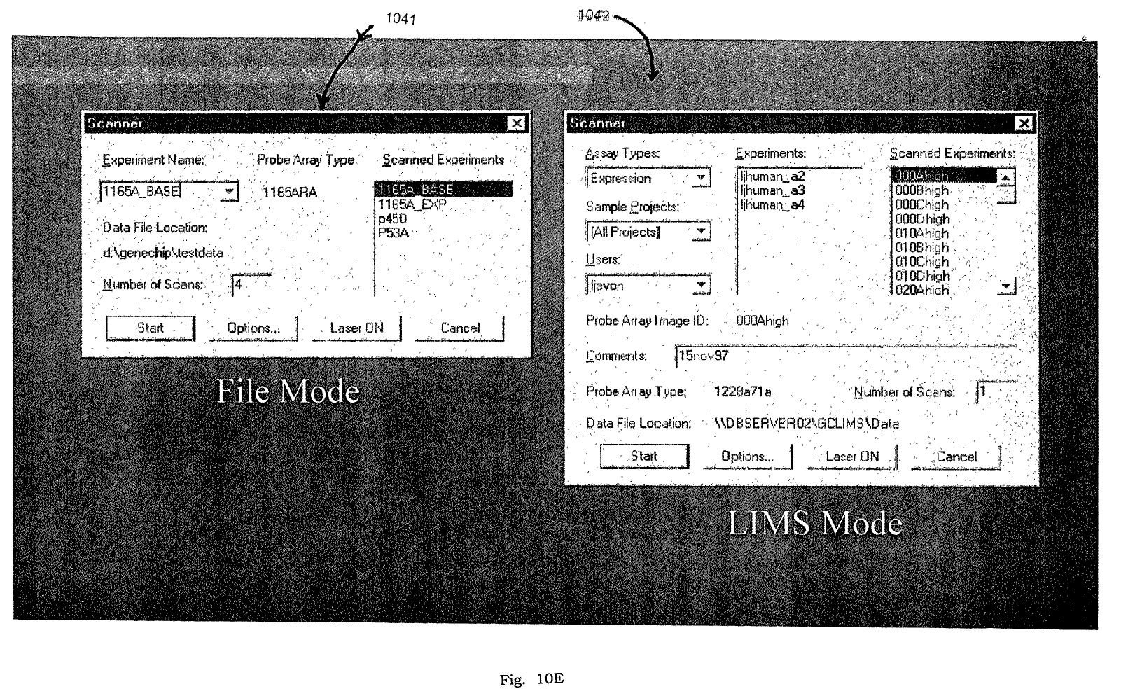

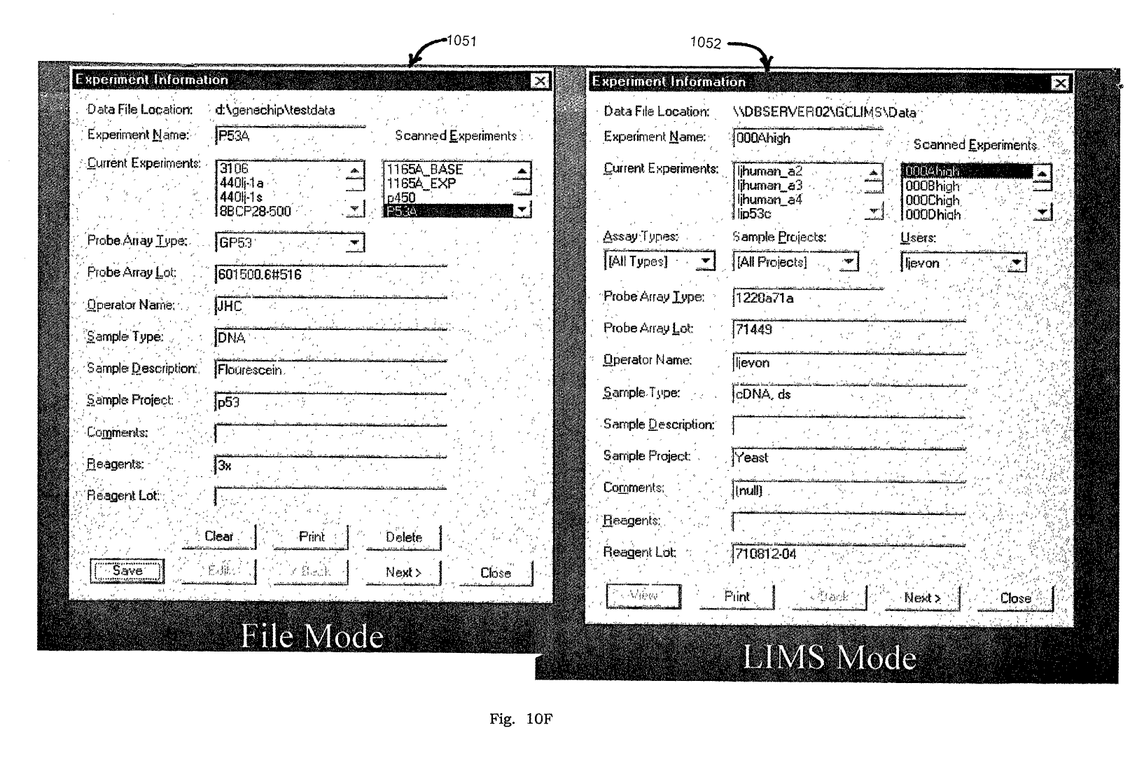

FIG. 10A illustrates screens for searching external databases in a particular embodiment according to the present invention. This diagram is merely an illustration and should not limit the scope of the claims herein. One of ordinary skill in the art would recognize other variations, modifications, and alternatives. FIG. 10A illustrates a probe set description dialog screen 1002 having a probe set name, a description and various annotations. The user can search using the probe set description dialog screen 1002 for information corresponding to the description in external databases. By selecting the entrez database in dialog screen 1002, a browser window 1004 is displayed. Browser window 1004 provides for browsing information about gene genetic expression sequences and the like in external databases such as the entrez database. In a presently preferred embodiment, a URL can be associated with a particular probe set. Further, multiple URLs can be associated for a particular probe set and a browser window can be automatically activated by the system to display relevant information about a probe set from external databases.

FIG. 10B illustrates a FAQ display selection screen in a particular embodiment according to the present invention. This diagram is merely an illustration and should not limit the scope of the claims herein. One of ordinary skill in the art would recognize other variations, modifications, and alternatives. FIG. 10B illustrates a FAQ selection screen 1008 having a plurality of frequently used searches. A user can perform one of the searches by simply selecting the desired search. A dialog screen 1010 can be displayed to the user upon selection of a particular FAQ. Dialog screen 1010 provides a plurality of questions that the user can answer in order to define the selected search. In a presently preferable embodiment, FAQs can be stored in data mining information database 306. Questions associated with a particular query, English translations and SQL statements can also be stored in the database with the FAQ.

FIG. 10C illustrates a gene chip migration screen in a particular embodiment according to the present invention. This diagram is merely an illustration and should not limit the scope of the claims herein. One of ordinary skill in the art would recognize other variations, modifications, and alternatives. FIG. 10C illustrates gene chip migration screen 1022 having a display area for local files in a plurality of formats 1024, a display area 1026 indicating data to migrate, a status area 1028 and a LIMS sample area 1030. The migration screen can be used to add gene chip data to the LIMS. In a preferred embodiment, it can facilitate association of information about samples, experiments, scan data and results. Further, some embodiments can perform simulations of workflow.

FIG. 10D illustrates fluidics station control screens 1031 and 1032 in a particular embodiment according to the present invention. This diagram is merely an illustration and should not limit the scope of the claims herein. One of ordinary skill in the art would recognize other variations, modifications, and alternatives. Fluidics control screens 1031 and 1032 can provide the user with the capability to control a fluidics station based upon selection of particular experiment names and protocols. The user can specify assay types, sample projects, reagents and protocols using the fluidics control screens.

FIG. 10E illustrates a scanner control screens 1041 and 1042 for controlling the scanning to a local drive or to a network in particular embodiment according to the present invention. This diagram is merely an illustration and should not limit the scope of the claims herein. One of ordinary skill in the art would recognize other variations, modifications, and alternatives. Scan control screens 1041 and 1042 provide the capability to the user to specify experiment name, probe array types, number of scans to be performed, assay-types, sample projects, experiments and a display of the scanned experiments.

FIG. 10F illustrates experiment information screens 1051 and 1052 in a particular embodiment according to the present invention. This diagram is merely an illustration and should not limit the scope of the claims herein. One of ordinary skill in the art would recognize other variations, modifications, and alternatives. Experiment information screens 1051 and 1052 provide the user with the capability to specify experiment names, probe array, probe array lots, operators, sample types, sample descriptions, projects, comments, reagents and reagent lots.

In conclusion the present invention provides for a method for managing laboratory operations for genetic expression monitoring and sequence analysis. One advantage is that the method provides better access to genetic expression information than methods known in the prior art. Another advantage provided by this approach is that the status of experiments which are in progress can be readily determined.

It is understood that the examples and embodiments described herein are for illustrative purposes only and that various modifications or changes in light thereof will be suggested to persons skilled in the art and are to be included within the spirit and purview of this application and scope of the appended claims. For example, tables may be deleted, contents of multiple tables may be consolidated, or contents of one or more tables may be distributed among more tables than described herein to improve query speeds and/or to aid system maintenance. Also, the database architecture and data models described herein are not limited to biological applications but may be used in any application. All publications, patents, and patent applications cited herein are hereby incorporated by reference.

What is claimed is:

1. A computer based method for managing information about a plurality of experiments conducted on a plurality of samples, wherein each experiment provides an indication of a degree of expression of particular genetic sequences in a sample, said method comprising:
registering at least one of said plurality of samples with a centralized database;
tracking a plurality of information about said plurality of samples;
tracking a plurality of information about said plurality of experiments;
producing a sample history about said plurality of samples from said plurality of information;
filtering said plurality of information about said plurality of experiments and said plurality of information about said plurality of samples according to filter input by a user to form a plurality of expression sequence information;
publishing said plurality of expression sequence information; and
providing a web based user interface to said user to enable the user to access said information.

2. The method of claim 1 wherein said information about said plurality of experiments includes a status of each of said plurality of experiments.

3. The method of claim 1 wherein said information about said plurality of experiments includes a result for each of said plurality of experiments.

4. The method of claim 1 wherein said information about said plurality of experiments includes a probe array type of each of said plurality of experiments.

5. The method of claim 1 wherein said information about said plurality of experiments includes a probe array lot number of each of said plurality of experiments.

6. The method of claim 1 wherein said information about said plurality of sample includes a sample type of each of said plurality of experiments.

7. The method of claim 1 wherein said information about said plurality of sample includes a sample project of each of said plurality of experiments.

8. The method of claim 1 wherein said plurality of experiments includes at least two experiments for each sample in said plurality of samples.

9. The method of claim 1 wherein said plurality of experiments includes one experiment for at least two samples in said plurality of samples.

10. A system for tracking information obtained from a plurality of gene expression sequence experiments, said system comprising:
a server, having a data storage, said server operatively disposed to registering at least one of said plurality of samples with a centralized database;
tracking a plurality of information about said plurality of samples;
tracking a plurality of information about said plurality of experiments;
producing a sample history about said plurality of samples from said plurality of information;
filtering said plurality of information about said plurality of experiments and said plurality of information about said plurality of samples according to filter input by a user to form a plurality of expression sequence information;
publishing said plurality of expression sequence information; and
providing a web based user interface to said user to enable the user to access said information.

11. The system of claim 10 wherein said data storage is a GATC compliant database.

12. The system of claim 10 wherein said data storage is a plurality of relational databases.

13. The system of claim 10 further comprising a client connected to said server, said client operatively disposed to submit queries to said data storage of said server, said client further operatively disposed to receive responses from said server containing information contained in said data storage.

14. The system of claim 13 wherein said client and said server are interconnected by an internetwork.

15. A method for viewing a result of a plurality of experiments conducted on a plurality of samples, said results stored in at least one of a plurality of databases, said method comprising the steps:
specifying which database to query;
submitting at least one of a plurality of queries to form a result;
viewing said result;
filtering said result according to at least one of a plurality of user specified factors of interest to form a filtered result; and
putting said filtered result into a graphical form.

16. A computer program product for managing information about a plurality of experiments conducted on a plurality of samples, wherein each experiment provides an indication of a degree of expression of particular genetic sequences in a sample, said product comprising:
code for registering at least one of said plurality of samples with a centralized database;
code for tracking a plurality of information about said plurality of samples;
code for tracking a plurality of information about said plurality of experiments;
code for producing a sample history about said plurality of samples from said plurality of information;
code for filtering said plurality of information about said plurality of experiments and said plurality of information about said plurality of samples according to filter input by a user to form a plurality of expression sequence information;
code for publishing said plurality of expression sequence information;
code for providing a web based user interface to said user to enable the user to access said plurality of expression sequence information; and
a computer readable storage medium for holding the codes.

17. The computer program product of claim 16 wherein said information about said plurality of experiments includes a status of each of said plurality of experiments.

18. The computer program product of claim 16 wherein said information about said plurality of experiments includes a result for each of said plurality of experiments.

19. The computer program product of claim 16 wherein said information about said plurality of experiments includes a probe array type of each of said plurality of experiments.

20. The computer program product of claim 16 wherein said information about said plurality of experiments includes a probe array lot number of each of said plurality of experiments.

21. The computer program product of claim 16 wherein said information about said plurality of sample includes a sample type of each of said plurality of experiments.

22. The computer program product of claim 16 wherein said information about said plurality of sample includes a sample project of each of said plurality of experiments.

23. The computer program product of claim 16 wherein said plurality of experiments includes at least two experiments for each sample in said plurality of samples.

24. The computer program product of claim 16 wherein said plurality of experiments includes one experiment for at least two samples in said plurality of samples.

25. A computer based method for managing information about a plurality of experiments conducted on a plurality of samples, wherein each experiment provides an indication of a degree of expression of particular genetic sequences in a sample, said method comprising:
tracking information about said plurality of experiments conducted on said plurality of samples to form a database of information;
analyzing the results of the tracking step;
querying the database.
